(19) United States
(12) Patent Application Publication
(10) Pub. No.: US 2025/0208838 A1
(43) Pub. Date: Jun. 26, 2025

(54) DEVELOPMENT ENVIRONMENT FOR AUTOMATICALLY GENERATING CODE USING A MULTI-TIERED METADATA MODEL

(71) Applicant: Ab Initio Technology LLC, Lexington, MA (US)

(72) Inventors: Dusan Radivojevic, North Andover, MA (US); Jonah Egenolf, Winchester, MA (US)

(21) Appl. No.: 18/987,691

(22) Filed: Dec. 19, 2024

Related U.S. Application Data
(60) Provisional application No. 63/616,206, filed on Dec. 29, 2023.
(60) Provisional application No. 63/613,579, filed on Dec. 21, 2023.

(51) Int. Cl. G06F 8/35; G06F 3/04842; G06F 8/41; G06F 40/30

(52) U.S. Cl. CPC G06F 8/35; G06F 3/04842; G06F 8/41; G06F 40/30

(57) ABSTRACT

A method for using a development environment to automatically generate code from a multi-tiered metadata model includes: receiving a specification to process a dataset, and, in response, accessing dataset characteristics and identifying controls received from a development environment to be applied to a field of the dataset in accordance with a metadata model by: accessing a first instance of a data structure that corresponds to the dataset; based on a reference in the first instance, accessing a second instance of a data structure associated with the field; based on a reference in the second instance, accessing a third instance of a data structure associated with metadata describing the field, and based on a reference in the third instance, accessing a fourth instance of a data structure storing a control defined based on the metadata. Based on the dataset characteristics, code is generated to apply the identified control to the field.

### CROSS-REFERENCE TO RELATED APPLICATIONS

This application claims priority to and the benefit of U.S. Provisional Patent Application No. 63/613,579, filed Dec. 21, 2023, and U.S. Provisional Patent Application No. 63/616,206, filed Dec. 29, 2023, the entire content of each of which is incorporated herein by reference.

### TECHNICAL FIELD

This disclosure relates to development environments, systems, and methods for automatically generating code or other logic using a multi-tiered metadata model. Specifically, this disclosure provides a development environment that visualizes items of metadata and enables controls to be defined based on that metadata through graphical or visual programming approaches. These defined controls are then used to automatically generate code for processing data that is related to the metadata according to a metadata model.

### BACKGROUND

Data governance involves the establishment of policies and procedures to ensure high data quality, security, and regulatory compliance. Traditionally, data governance has relied on manual processes in which a data steward specifies the requirements for data, and developers implement these requirements using program code. While effective in smaller environments, these manual approaches often become inefficient as data volumes and complexities increase, leading to inconsistencies and errors that can compromise the integrity of governance efforts.

### SUMMARY

In general, in a first aspect, a method implemented by a data processing system for improving data governance by defining a single control based on a semantic meaning of data and enabling the single control to be automatically applied to multiple, disparate data elements associated with the semantic meaning to govern the data elements, the method including: storing, in a data store, a metadata model including one or more first items of metadata and one or more second items of metadata, with at least one of the one or more first items of metadata specifying a semantic meaning associated with at least one of the one or more second items of metadata, wherein the metadata model specifies a relationship between the at least one of the one or more first items of metadata and the at least one of the one or more second items of metadata; receiving, by a data processing system, a control defined based on the at least one of the one or more first items of metadata specifying the semantic meaning; updating, by a data processing system, the metadata model to include a third item of metadata representing the control; specifying, by a data processing system, a relationship between the third item of metadata representing the control and the at least one of the one or more first items of metadata; and storing, in the data store, the updated metadata model with the specified relationship for the control to be applied to one or more data elements associated with the at least one of the one or more second items of metadata with the relationship in the metadata model to the at least one of the one or more first items of metadata.

In a second aspect combinable with the first aspect, operations of the method include rendering, by a data processing system, a user interface including one or more visualizations of the one or more first items of metadata; receiving, by a data processing system and from the user interface, selection data specifying selection of at least one of the one or more visualizations and one or more operations to be applied to data associated with the at least one of the one or more visualizations, the at least one of the one or more visualizations corresponding to the at least one of the one or more first items of metadata specifying the semantic meaning; and generating, by a data processing system and based on the selection data, the control defined based on the at least one of the one or more first items of metadata specifying the semantic meaning.

In a third aspect combinable with the first or second aspects, operations of the method include receiving, by a data processing system, a specification to process the one or more data elements; responsive to the specification, identifying, based on the metadata model, the at least one of the one or more second items of metadata associated with the one of the one or more data elements; identifying, based on the metadata model, the at least one of the one or more first items of metadata related to the at least one of the one or more second items of metadata; identifying, based on the metadata model, the third item of metadata representing the control defined based on the at least one of the one or more first items of metadata specifying the semantic meaning; and generating instructions for applying the control to the one or more data elements; and executing the instructions to apply the control to the one or more data elements.

In a fourth aspect combinable with any of the first through third aspects, operations of the method include applying, by the data processing system, the control to the one or more data elements by accessing data specifying one or more characteristics of the one or more data elements or one or more datasets including the one or more data elements; based on the data specifying the one or more characteristics, generating instructions for applying the control to the one or more data elements, and executing the instructions to apply the control to the one or more data elements.

In a fifth aspect combinable with any of the first through fourth aspects, generating the instructions for applying the control to the one or more data elements includes generating first instructions for accessing, from a data store, one or more values of the one or more data elements; generating second instructions for applying the control to the one or more values of the one or more data elements, the second instructions including at least one operation to be performed on the one or more values of the one or more data elements based on the data specifying the one or more characteristics; and generating third instructions for storing the one or more values of the first of the dataset to which the control is applied.

In a sixth aspect combinable with any of the first through fifth aspects, the control is defined based on at least two of the one or more first items of metadata specifying the semantic meaning, the method including: applying, by a data processing system, the control, by: identifying, based on the metadata model, one of the one or more second items of metadata related to each of the at least two of the one or more first items of metadata; accessing data specifying a correlation between the one of the one or more second items of metadata related to each of the at least two of the one or more first items of metadata; based on the data specifying the correlation, generating instructions for applying the control to a data element associated with the one of the one or more second items of metadata related to each of the at least two of the one or more first items of metadata, and executing the instructions to apply the control to the data elements.

In a seventh aspect combinable with any of the first through sixth aspects, generating the instructions based on the data specifying the correlation includes: based on the data specifying the correlation, generating instructions for joining a data element associated with the one of the one or more second items of metadata related to each of the at least two of the one or more first items of metadata; and generating instructions for applying the control to the joined data elements.

In an eighth aspect combinable with any of the first through seventh aspects, updating the metadata model to include the third item of metadata representing the control includes generating an instance of a data structure that includes the metadata representing the control and wherein the relationship between the third item of metadata representing the control and the at least one of the one or more first items of metadata is specified by the instance of the data structure including a reference to another instance of a data structure associated with the at least one of the one or more first items of metadata, or the other instance of the data structure associated with the at least one of the one or more first items of metadata including a reference to the instance of the data structure.

In a ninth aspect combinable with any of the first through eighth aspects, the instructions for applying the control to the one or more data elements are code.

In a tenth aspect combinable with any of the first through ninth aspects, the control is applied to the one or more data elements in accordance with the characteristics of: the one or more data elements, or one or more datasets including the one or more data elements, to which the control is applied.

In an eleventh aspect combinable with any of the first through tenth aspects, the metadata model incorporates the data specifying the one or more characteristics, such as into links between items of the second items of metadata.

In a twelfth aspect combinable with any of the first through eleventh aspects, the data specifying the one or more characteristics includes data specifying the data types of the one or more data elements or the one or more datasets including the one or more data elements.

In a thirteenth aspect combinable with any of the first through twelfth aspects, the data specifying one or more characteristics of the one or more data elements, or one or more datasets including the one or more data elements, include information about intra- and/or inter-dataset relationships, and the applying of the control to one or more data elements includes applying the control across multiple data elements within the same or different one or more datasets.

In a fourteenth aspect combinable with any of the first through thirteenth aspects, the one or more characteristics include information identifying at least one of a primary key, a record format, a data type of a field, or a primary-foreign key relationship with another dataset.

In a fifteenth aspect combinable with any of the first through fourteenth aspects, executing of the instructions includes: compiling the instructions to produce executable code; and executing the executable code to apply the control to the one or more data elements.

In general, in a sixteenth aspect, a method implemented by a data processing system for using a development environment to automatically generate code from a multi-tiered metadata model, the method including: receiving, by a data processing system, a specification to process at least a portion of a dataset; responsive to the specification, accessing, by a data processing system, one or more characteristics of the dataset; and identifying, by a data processing system, one or more controls received from a development environment to be applied to one or more values of a field of the dataset in accordance with a metadata model, by: accessing a first instance of a data structure storing an identifier that corresponds to the dataset; based on a reference to a second instance of a data structure stored in the first instance of the data structure, accessing the second instance of the data structure associated with the field of the dataset; based on a reference to a third instance of a data structure stored in the second instance of the data structure, accessing the third instance of the data structure associated with metadata that describes one or more values of the field of the dataset; based on a reference to a fourth instance of a data structure stored in the third instance of the data structure, accessing the fourth instance of the data structure storing a control defined based on the metadata that describes one or more values of the field of the dataset; and identifying the control from the fourth instance of the data structure; based on the one or more characteristics of the dataset, generating, by a data processing system, code for applying the identified control to the one or more values of the field of the dataset; and executing the code to apply the control to the one or more values of the field of the dataset.

In a seventeenth aspect combinable with the sixteenth aspect, the one or more characteristics of the dataset include at least one of a primary key of the dataset, a record format of the dataset, or a data type of the field of the dataset.

In an eighteenth aspect combinable with the sixteenth or seventeenth aspects, the one or more characteristics of the dataset include a primary-foreign key relationship with another dataset.

In a nineteenth aspect combinable with any of the sixteenth through eighteenth aspects, the reference stored in each of the first instance of the dataset, the second instance of the dataset, and the third instance of the dataset is a respective pointer to a memory location at which the instance of the data structure referred to by the reference is stored.

In a twentieth aspect combinable with any of the sixteenth through nineteenth aspects, generating the code for applying the control to the one or more values of the field of the dataset includes generating first code for accessing the one or more values of the field of the dataset from a data store; generating second code for applying the control to the one or more values of the field of the dataset, the second code including at least one operation to be performed on the one or more values of the field of the dataset based on the determined one or more characteristics of the dataset; and generating third code for storing the one or more values of the first of the dataset to which the control is applied.

In a twenty-first aspect combinable with any of the sixteenth through twentieth aspects, the at least one operation comprises an operation to transform a data type of the one or more values of the field of the dataset.

In a twenty-second aspect combinable with any of the sixteenth through twenty-first aspects, the at least one operation comprises an operation to join the one or more values of the field of the dataset with one or more values of a field of another dataset.

In a twenty-second aspect combinable with any of the sixteenth through twenty-first aspects, the control is defined based on the metadata that describes the one or more values of the field of the dataset and second metadata that describes one or more values of a field of another dataset.

In a twenty-third aspect combinable with any of the sixteenth through twenty-second aspects, generating the code for applying the control to one or more values of the field of the dataset includes generating code for joining the one or more values of the field of the dataset with the one or more values of the field of the other dataset; and generating code for applying the control to the joined one or more values of the field of the dataset and the one or more values of the field of the other dataset.

In a twenty-fourth aspect combinable with any of the sixteenth through twenty-fifth aspects, operations of the method include: segmenting the metadata model; and identifying, based on the segmented metadata model, the one or more controls to be applied to the one or more values of the field of the dataset.

In a twenty-fifth aspect combinable with any of the sixteenth through twenty-fourth aspects, executing the code includes: compiling the code to produce executable code; and executing the executable code to apply the control to the one or more values of the field of the dataset.

In a twenty-sixth aspect combinable with any of the sixteenth through twenty-fifth aspects, applying the identified control to the one or more values of the field of the dataset includes executing code on the one or more values of the field of the dataset, to which the control is applied, in accordance with the characteristics of the datasets to which the control is applied.

In a twenty-seventh aspect combinable with any of the sixteenth through twenty-sixth aspects, the one or more characteristics include information about intra- and/or inter-dataset relationships, and applying the identified control to the one or more values of the field of the dataset includes applying executable code across multiple fields within the same or different one or more datasets.

In general, in a twenty-eighth aspect, a data processing system includes one or more processors and memory storing instructions executable by the one or more processors to perform the method of any of the first through nineteenth aspects.

In general, in a twenty-ninth aspect, one or more non-transitory computer-readable storage media store instructions executable by one or more processors to perform the method of any of the first through nineteenth aspects.

In general, in a thirtieth aspect, an apparatus includes one or more processors and memory storing instructions executable by the one or more processors to perform the method of any of the first through nineteenth aspects.

One or more of the above aspects may provide one or more of the following advantages.

Data continuously grows over time and needs to be governed. However, governing this data through controls (e.g., rules or other logic, such as executable logic) defined at the physical level (e.g., dataset or data element level) is unsustainable and costly. This is because, for each new dataset, new logic would need to be defined to govern that new dataset, creating a continuous and expensive cycle of constantly defining new rules.

The techniques described here provide a development environment that enables a non-technical user to define metadata controls, rules, and other logic at a logical level. These controls are then automatically propagated down to data, including existing data and new data added into the system after the control has been defined. As such, new controls do not need to be defined for each new dataset that is added to a system. Once an entity has done the upfront work of defining all the controls needed to govern various datasets, the system described here automatically applies those controls to new and existing datasets, thereby making data governance efficient. This is because controls tend to stabilize over time. Once the controls have been defined, the system can automatically apply these controls to new datasets without new controls having to be defined. In this way, the techniques described here perform data governance more efficiently and with less resource consumption relative to systems that perform governance by defining controls individually for each dataset.

The techniques described here also improve the accuracy and robustness of metadata-based data governance and other data processing by using a metadata model that incorporates characteristics of datasets into the links between items of technical metadata, which represent data, and items of logical metadata, which give meaning to the technical metadata. For example, the metadata model can include metadata specifying the data types, scope (e.g., system or application), and other attributes of datasets or their data elements, which allows top-level controls to be transformed into executable logic in a way that accounts for the physical level characteristics of the underlying data. In addition, the metadata model can include information about intra- and inter-dataset relationships, which enables top-level controls to be defined across multiple data elements within the same or different datasets. In this manner, arbitrarily complex controls, rules, and other logic can be defined at a logical level and then automatically and accurately applied to both new and existing data at the physical level.

Improvements to metadata controls used for data governance are also described. In particular, a templated control is described in which the control is defined without reference to any specific item of data. In this manner, the templated control only needs to be defined once before being applied across some or all of the data described in a metadata model, thereby increasing the efficiency with which the data is governed. In addition, anomaly detection controls are described that are configured to identify anomalies in defined segments of a metadata model, thereby facilitating the identification of a root cause of data quality issues.

Furthermore, a data structure is described which has multiple connected instances. The inventors have recognized that using these multiple instances of the data structure, each preferably linked via a pointer in memory, the computer can be controlled along its path to the desired control code to be applied to a dataset in a way that is particularly computationally efficient.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagram of an example metadata model.

FIGS. 2A and 2B are diagrams of example systems for generating and applying metadata controls for data processing.

FIGS. 3A and 3B are diagrams of example systems for generating metadata controls.

FIGS. 4A and 4B are diagrams of example systems for applying metadata controls for data processing.

FIG. 4C is a diagram of an example interface visualizing the results of applying metadata controls.

FIG. 5 is a diagram of an example system for applying metadata controls to new data.

FIGS. 6A and 6B are diagrams of example systems for applying metadata controls across multiple datasets.

FIGS. 7A and 7B are diagrams of example systems for applying templated controls.

FIG. 8 is a diagram of an example system for applying controls for anomaly detection.

FIGS. 9 and 10 are flow diagrams of example processes for generating and applying metadata controls for data processing.

FIG. 11 is a diagram of an example computing system.

### DETAILED DESCRIPTION

Modern data processing systems store overwhelming volumes of complex data that needs to be governed or otherwise managed. For example, a data processing system of a large organization may store millions of datasets (e.g., tables or files), with each dataset containing multiple data elements (e.g., columns or fields) that need to be governed. This data is dynamic, and the amount of data continuously grows over time. Given the sheer scale of data, it is not feasible to govern data at the physical level, as defining controls (e.g., rules or other logic) for each dataset or data element would be overly time-consuming and resource-intensive. Moreover, for each new dataset or data element that is stored, new controls would need to be defined to govern that new dataset or data element, creating a perpetual cycle of constantly defining controls.

While the amount of data stored by a data processing system continuously grows, the number of logical concepts that describe the data tends to level off. Thus, to make large-scale data governance more manageable, the techniques described herein use metadata to link the data to logical concepts to enable governance of the data at the logical concept level. For example, a data processing system can store technical metadata that specifies the names of the data elements within its data store(s). The data processing system can also store logical metadata specifying the logical concepts that describe or give meaning to the data elements. Manual and/or automatic processes can then be performed to link each item of technical metadata to a corresponding item of logical metadata. Once linked, data governance controls can be specified with respect to an item of logical metadata and automatically applied to linked items of technical metadata. By using metadata to link a large number of data elements to a relatively small number of logical concepts, the number of controls that need to be defined to govern data can be significantly reduced.

In some cases, directly linking technical metadata and logical metadata may not provide sufficient information to govern the underlying data effectively. In general, the data stored by an organization often resides in several different systems or applications, each having different capabilities. This data can have a wide range of different data types, data formats, and other characteristics. In addition, the data may have specific relationships, both within a single dataset and across multiple datasets. Using metadata to link data elements to logical concepts, without more, may not provide this contextual information, leading to subpar data governance. For example, if multiple data elements containing data of different types are linked to the same logical concept, a control defined with respect to that logical concept may operate as intended when executed against a data element containing data of one data type (e.g., integer), but may produce errors when executed against another data element containing data of a different data type (e.g., string). In addition, without knowledge of the relationships among datasets or data elements, it may not be possible to implement controls that involve multiple data elements within the same or different datasets.

To address these and other issues, the present disclosure describes techniques for improved metadata-based data governance using a multi-tiered metadata model that incorporates characteristics of datasets into the flow among items of technical metadata, which represent data, and items of logical metadata, which give meaning to the technical metadata. For example, the metadata model can include metadata specifying the data types, scope (e.g., system or application), and other attributes of datasets or their data elements, which allows top-level controls to be resolved in a way that takes the physical level characteristics of the underlying data into account. In addition, the metadata model can include information about intra- and inter-dataset relationships, which enables top-level controls to be defined across multiple data elements within the same or different datasets. In this manner, arbitrarily complex controls, rules, and other logic can be defined at a logical level, and then automatically propagated down to data, including both existing data and new data added into the system after the controls have been defined. As a result, the number of controls that need to be defined to govern new and existing data within a system is significantly reduced, thereby enabling data governance with increased efficiency and reduced resource consumption relative to systems that govern at the physical level.

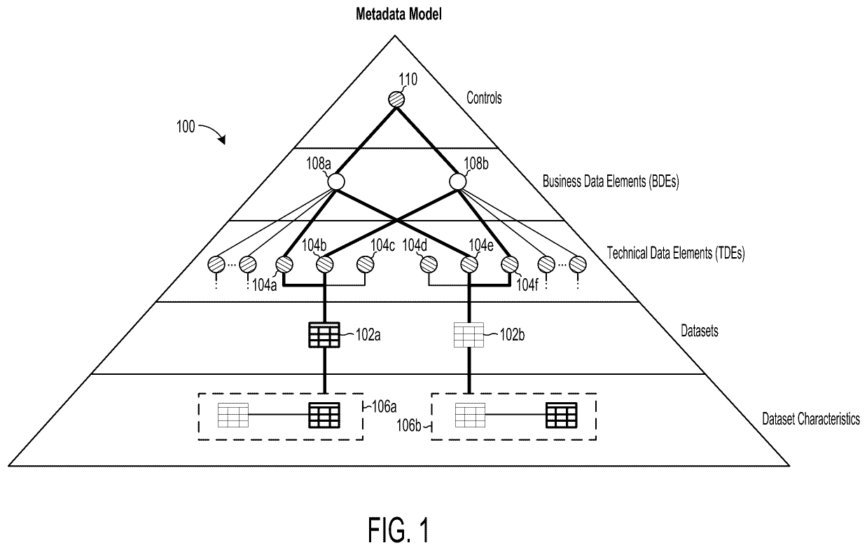

Referring to FIG. 1, an example metadata model 100 is shown. In general, a metadata model is a structured representation of metadata and relationships among the metadata. For example, the metadata model can be an object model or a data structure (e.g., a schema) that includes nodes representing items of metadata (e.g., technical or logical metadata) and edges representing relationships among the items of metadata. In general, technical metadata includes metadata that describes attributes of stored data, such as its technical name (e.g., dataset name, field name, etc.). Logical metadata includes metadata that gives meaning or context to data, such as its semantic or business name.

A node can be a data object or other data structure that includes values for attributes of the item of metadata that it represents. The attributes included in a node can depend on the type or class of metadata that the node represents. For example, a node representing a dataset can include a dataset name attribute that is populated with the name of the dataset that the node represents.

An edge can be a reference, a pointer, a data object, or another data structure that specifies a relationship between nodes. In some examples, an edge can represent a hierarchical relationship between nodes (e.g., a parent-child relationship), such as a relationship between a dataset node (the parent) and a node of a technical data element it contains (the child). As another example, an edge can represent an associative relationship between nodes, such as a relationship between a technical data element node and a business data element node that describes or gives meaning to the technical data element node.

In this example, metadata model 100 is a multi-tiered metadata model that includes several tiers or layers corresponding to different types of metadata, with nodes in a given layer representing an item of metadata of that type. For example, metadata model 100 has a dataset layer that includes nodes 102a, 102b specifying metadata for datasets that are stored in a data store or other storage device. Each of nodes 102a, 102b can specify values for one or more attributes of a dataset, such as the name of the dataset. Although only two nodes 102a, 102b are shown in this example, other examples can include many more nodes (e.g., thousands or millions) representing all of the datasets stored in a data processing system.

Above the dataset layer is a technical data element (TDE) layer that includes nodes 104a, . . . , 104f specifying metadata for TDEs (e.g., columns or fields) of a dataset. For example, each of nodes 104a, . . . , 104f can specify a name of the corresponding TDE, among other attributes. In this example, nodes 104a, . . . , 104c represent TDEs of the dataset corresponding to node 102a, and nodes 104d, . . . , 104f represent TDEs of the dataset corresponding to node 102b. To establish this relationship in metadata model 100, each of TDE nodes 104a, . . . , 104c can be connected to dataset node 102a by an edge (e.g., a reference, a pointer, a data object, etc.), and each of TDE nodes 104d, . . . , 104f can be connected to dataset node 102b by an edge.

Metadata model 100 also includes a business data element (BDE) layer. In general, nodes 108a, 108b in the BDE layer specify logical names, terms, or other metadata that describes or gives meaning to TDEs and their underlying data. To identify such a link or association between a BDE and a TDE, semantic discovery processes can be used in which a series of statistical checks on a TDE and its associated data are performed in order to discover, classify, and label the TDE (and its data) with a BDE representing their semantic meaning. Additional details regarding the semantic discovery processes are described in U.S. Pat. No. 11,704,494, titled “Discovering a semantic meaning of data fields from profile data of the data fields,” the entire content of which is incorporated herein by reference.

In this example, TDE nodes 104a, 104e each relate to the same logical concept represented by BDE node 108a, and TDE nodes 104b, 104f each relate to the same logical concept represented by BDE node 108b. Stated differently, BDE node 108a describes or gives meaning (e.g., a semantic meaning) to each of TDE nodes 104a, 104e, and BDE node 108b describes or gives meaning to each of TDE nodes 104b, 104f. BDE nodes 108a, 108b can also describe or give meaning to other TDE nodes, as depicted in FIG. 1. Accordingly, TDE nodes 104a, 104e are linked (e.g., by edges) to BDE node 108a, and TDE nodes 104b, 104f are linked to BDE node 108b. By linking TDEs and BDEs, valuable context can be provided to the cryptic names of TDEs (e.g., X152) that convey little about the type of information they represent. In addition, controls defined with respect to a BDE can be automatically propagated to multiple linked TDEs, thereby reducing the number of controls that need to be defined.

Above the BDE layer is a controls layer that includes a node 110 specifying metadata that defines a control (e.g., a rule or other logic) for governing data. In general, a control may refer to rules or other logic, which may be compiled into executable logic or executable code that is executable to apply the control to data. In this example, the node 110 specifies metadata that defines a control with respect to the BDEs represented by nodes 108a, 108b, and therefore is linked to each of BDE nodes 108a, 108b by edges. In some examples, a control is defined with respect to one or more BDEs (or other logical elements in the metadata model) by referencing the BDE as a parameter in the control logic (e.g., Date of Birth>Jan. 1, 1900, where “Date of Birth” corresponds to a BDE). A control can also be a templated control that is written independent of any particular BDE or other data (e.g., check presence for fields with Required=Yes), but is nonetheless defined or specified as applicable to one or more BDEs. Controls can be manually or automatically created and can be of various types, such as monitoring controls that monitor data against criteria without altering the data, preventative controls that reject data that does not satisfy certain criteria, and corrective controls that correct data according to certain criteria, among others.

Metadata model 100 also includes a dataset characteristics layer. In general, the dataset characteristics layer specifies characteristics of datasets and their TDEs. For example, the dataset characteristics layer can include metadata specifying the data types, relationships (e.g., primary-foreign key relationships), record format, scope (e.g., system or application), and/or other attributes of datasets and their TDEs. In this example, the dataset characteristics layer includes nodes 106a, 106b with metadata specifying respective characteristics for the datasets represented by nodes 102a, 102b and their TDEs represented by nodes 104a, . . . , 104f. As described in detail herein, the information provided by the characteristics layer enables controls defined with respect to one or more BDEs to be resolved (e.g., transformed into executable instructions) in a way that accounts for the characteristics of datasets and TDEs, thereby ensuring that the top-level controls accurately execute against the physical-level data.

In some examples, the characteristics layer can be or include a definition of an expanded view dataset that specifies a base dataset (e.g., a dataset corresponding to one of the nodes 102a, 102b) and datasets related to the base dataset, and also specifies logic for generating an expanded view dataset (e.g., a wide record) that includes the data from the base dataset and the related datasets. For example, node 106a in the dataset characteristics layer can include a definition of an expanded view dataset that includes logic for joining (e.g., based on primary-foreign key relationships) a base dataset corresponding to node 102a with a related dataset corresponding to node 102b. Similarly, node 106b in the dataset characteristics layer can include a definition of an expanded view dataset that includes logic for joining a base dataset corresponding to node 102b with a related dataset corresponding to node 102a. Additional details regarding the expanded view dataset definition are described below and in U.S. patent application Ser. No. 18/492,904, titled “Logical Access for Previewing Expanded View Datasets,” the entire content of which is incorporated herein by reference. The expanded view dataset definition (and/or other characteristics specified in the dataset characteristics layer) are used to improve the accuracy and efficiency of metadata-based data governance, as described herein.

While the example metadata model 100 illustrated in FIG. 1 depicts a particular set of layers, additional or alternative layers can be used in some examples without departing from the scope of the present disclosure. For example, one or more additional logical layers, such as a business term layer and/or a business term group layer, can be included above the BDE layer, with controls defined with respect to nodes in the business term and/or business term group layers. As another example, the dataset characteristics layer may be combined with the dataset layer (e.g., by including the characteristics specified in the dataset characteristics layer in the dataset nodes in the dataset layer). In addition, although the metadata model 100 depicts a particular number of nodes in each layer, additional (or fewer) nodes can be included in some examples without departing from the scope of the present disclosure.

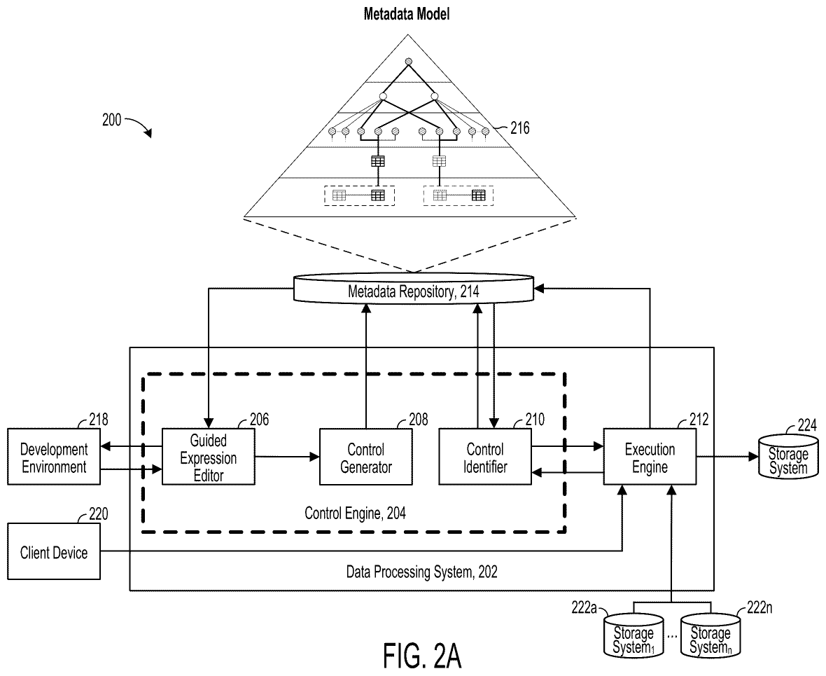

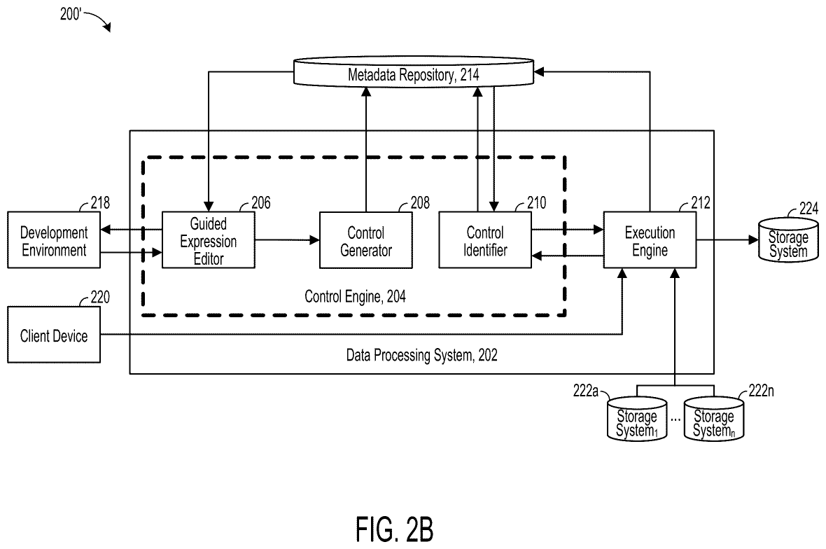

Referring to FIG. 2A, an example system 200 is shown for generating and applying metadata controls for data processing. In this example, system 200 includes a data processing system 202 having a metadata control engine 204, which in turn includes a guided expression editor 206, a control generator 208, and a control identifier 210. Data processing system 202 also includes an execution engine 212. In this example, system 200 also includes metadata repository 214 that stores, among other things, a metadata model 216 (which may be the same as or similar to metadata model 100 shown in FIG. 1).

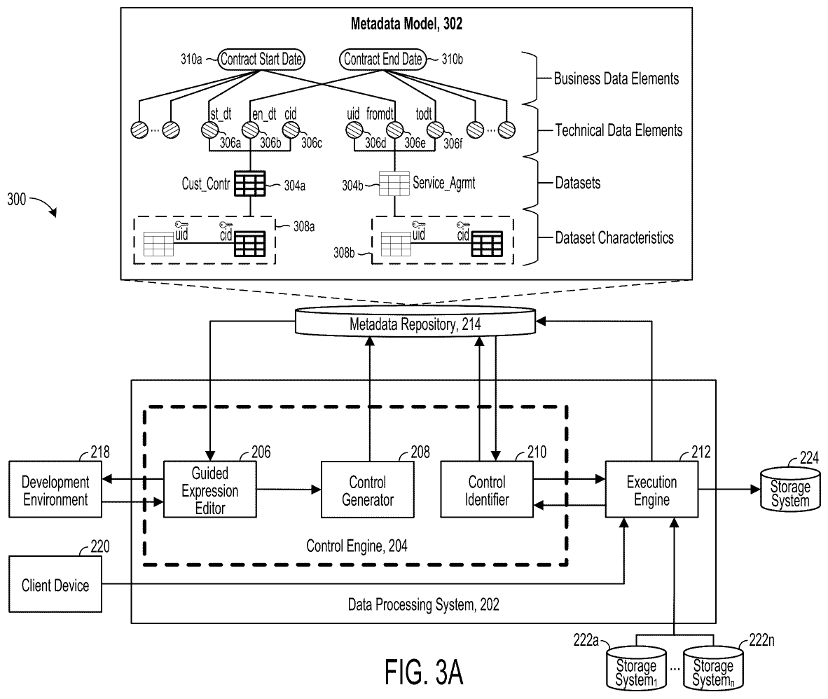

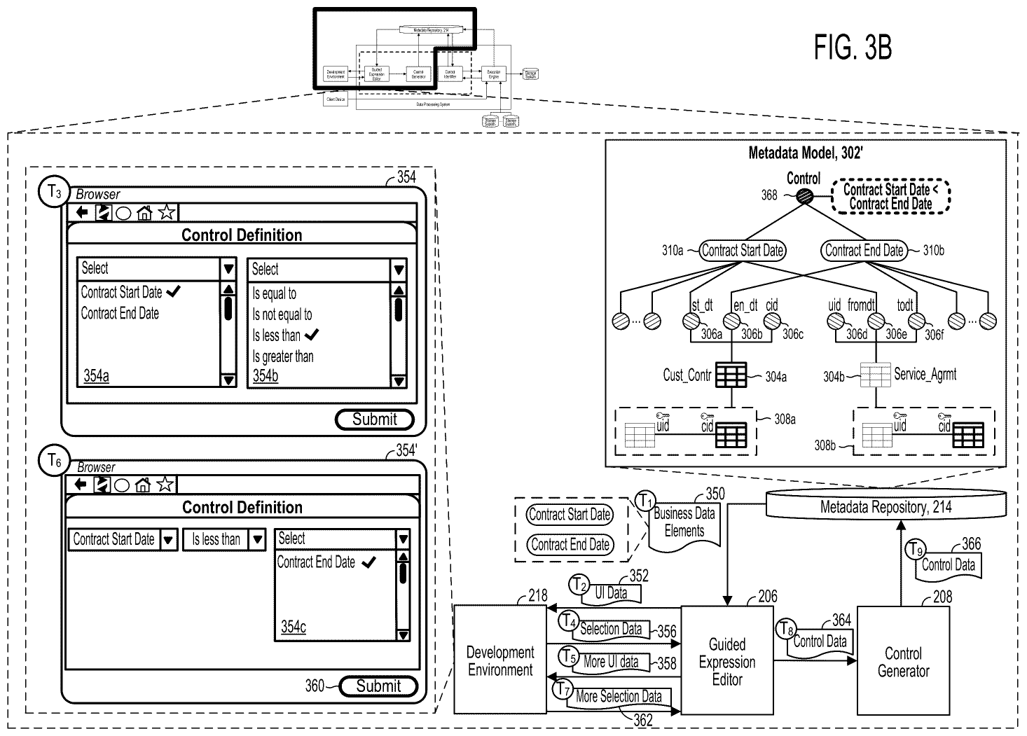

Guided expression editor 206 is configured to interact with a development environment 218 to provide a user interface that guides a user of the development environment 218 in generating, testing, and approving a control in an intuitive (e.g., no-code) manner. In particular, the guided expression editor 206 interacts with the metadata repository 214 (e.g., the metadata model 216) to identify valid parameters and operators that can be used in creating a control based on the current control state. Additional details regarding the guided expression editor 206 are described below with reference to FIG. 3B. Once a control has been generated and approved, the guided expression editor 206 transmits information about the control to control generator 208. Control generator 208 is configured to incorporate the control into metadata model 216 by, for example, adding a node to the metadata model 216 that specifies the control, and adding edges to link the control to other nodes (e.g., BDE nodes).

At times, a client device 220 (which may be the same as or different from the development environment 218) transmits data processing instructions to execution engine 212. For example, the client device 220 can transmit a specification to the execution engine 212 that includes instructions for generating and/or executing a computer program (e.g., a dataflow graph) to perform operations on data. In response, the execution engine 212 communicates with the control identifier 210, which is configured to traverse nodes and edges of the metadata model as described herein to identify controls and dataset characteristics that are applicable to the data to be processed. This information is passed to the execution engine 212, which generates an executable computer program that implements the controls based in part on the dataset characteristics. The execution engine 212 then executes the computer program on data retrieved from one or more storage systems 222a, . . . , 222n, and stores the governed output data in a storage system 224. Referring to FIG. 2B, a system 200′ is shown, which is a version of system 200′. Referring to FIG. 3A, an example system 300 is shown for generating and applying metadata controls for data processing. System 300 is a version of system 200, and some of the reference numbers in FIG. 3A are as described previously with reference to FIG. 2A.

In this example, system 300 includes metadata model 302. Metadata model 302 includes a node 304a specifying metadata for a dataset “Cust_Contr,” and a node 304b specifying metadata for a dataset “Service_Agrmt.” In some examples, nodes 304a, 304b can specify a name of the respective dataset. Metadata model 302 also includes nodes 306a, . . . , 306f specifying metadata for TDEs of the datasets “Cust_Contr” and “Service_Agrmt.” In particular, nodes 306a, 306b, and 306c specify names of TDEs “st_dt,” “en_dt,” and “cid” that are part of the dataset “Cust_Contr,” and nodes 306d, 306e, 306f specify names of TDEs “uid,” “fromdt,” and “todt” that are part of the dataset “Service_Agrmt.” To indicate these relationships, each of nodes 306a, 306b, 306c are connected to node 304a via an edge, and each of nodes 306d, 306e, 306f are connected to node 304b via an edge. For example, each of TDE nodes 306a, 306b, and 306c may include a reference or a pointer to a memory location of dataset node 304a, and/or dataset node 304a may include a reference or a pointer to a memory location of each of TDE nodes 306a, 306b, 306c. As another example, each of TDE nodes 306a, 306b, 306c may include a reference to a unique identifier of dataset node 304a, and/or dataset node 304a may include a reference to a unique identifier of each of TDE nodes 306a, 306b, 306c. Similar techniques can be used to implement the edges between other nodes (e.g., TDE nodes 306d, 306e, 306f and dataset node 304b, among others).

Metadata model 302 also includes a node 310a specifying metadata for a BDE “Contract Start Date,” and a node 310b specifying metadata for a BDE “Contract End Date.” For example, nodes 310a, 310b can specify a name of the respective BDE, among other attributes (e.g., a description). In this example, BDE node 310a (“Contract Start Date”) describes or gives meaning to TDE node 306a (“st_dt”) and TDE node 306e (“fromdt”), and BDE node 310b (“Contract End Date”) describes or gives meaning to TDE node 306b (“en_dt”) and TDE node 306f (“todt”). Such a relationship can be determined by, for example, performing semantic discovery. For example, data associated with TDE nodes 306a, . . . , 306f, such as data values in the fields corresponding to the TDE nodes, can be analyzed by a data processing system to generate a data profile for each TDE. In some examples, the data profile can include information representing statistical attributes for data values of the TDE, such as a minimum length of the data values of the TDE, a maximum length of the data values of the TDE, a most common data value of the TDE, a least common data value of the TDE, a maximum data value of the TDE, and/or a minimum data value of the TDE, among others. The data profiles can then be processed to discover, classify, and associate each TDE with a BDE having a term or label representing the semantic meaning of the TDE. For example, a plurality of classification tests (e.g., a pattern analysis, a business term analysis, a fingerprint analysis, and a keyword search, among others) can be performed on the profile data for a TDE to determine a BDE that most likely represents the semantic meaning of the TDE. Once a BDE is determined for a TDE, the metadata model 302 can be updated to include an edge that links the BDE and the TDE.

Also included in metadata model 302 are nodes 308a, 308b specifying characteristics of datasets and their TDEs. In this example, node 308a specifies characteristics of the dataset “Cust_Contr” corresponding to node 304a and its TDEs corresponding to nodes 306a-306c. For example, node 308a can specify that the “cid” field serves as a primary key for dataset “Cust_Contr” and the “st_dt” and “en_dt” fields within the dataset “Cust_Contr.” In other words, node 308a specifies that values of the “cid” field uniquely identify records containing values for the fields (e.g., “st_dt” and “en_dt”) within the dataset “Cust_Contr.” Node 308a can also specify, for example, that values of the “st_dt” field are of a date data type, and that values of the “en_dt” field are of a date data type. In some examples, node 308a specifies a definition of an expanded view dataset that includes “Cust_Contr” (as the base dataset and “Service_Agrmt” (as a related dataset). For example, node 308a can specify that the “Cust_Contr” and “Service_Agrmt” datasets are related to one another according to a primary-foreign key relationship, with the “cid” field in “Cust_Contr” serving as the primary key, and the “uid” field in “Service_Agrmt” serving as the foreign key. Node 308a can also include logic for joining “Cust_Contr” and “Service_Agrmt” based on the primary-foreign key relationship (e.g., by joining records of “Cust_Contr” and “Service_Agrmt” where values of “cid” match “uid”). In some examples, node 308a can also include characteristics for datasets related to “Cust_Contr” (e.g., “Service_Agrmt”) and their TDEs.

Metadata model 302 further includes node 308b specifying characteristics of the dataset “Service_Agrmt” corresponding to node 304b and its TDEs corresponding to nodes 306d-306f. For example, node 308b can specify that the “uid” field serves as a primary key for dataset “Service_Agrmt” and the “fromdt” and “todt” fields within the dataset “Service_Agrmt.” In other words, node 308b specifies that values of the “uid” field uniquely identify records containing values for the fields (e.g., “fromdt” and “todt”) within the dataset “Service_Agrmt.” Node 308b can also specify that values of the “fromdt” field are of a string data type, and that values of the “todt” field are of a string data type. In some examples, node 308b specifies a definition of an expanded view dataset that includes “Service_Agrmt” (as the base dataset and “Cust_Contr” (as a related dataset). For example, node 308b can specify that the “Service_Agrmt” and “Cust_Contr” datasets are related to one another according to a primary-foreign key relationship, with the “uid” field in “Service_Agrmt” serving as the primary key, and the “cid” field in “Cust_Contr” serving as the foreign key. Node 308b can also include logic for joining “Service_Agrmt” and “Cust_Contr” based on the primary-foreign key relationship (e.g., by joining records of “Service_Agrmt” and “Cust_Contr” where values of “uid” match “cid”). In some examples, node 308b can also include characteristics for datasets related to “Service_Agrmt” (e.g., “Cust_Contr”) and their TDEs, such as the characteristics described above.

Referring to FIG. 3B, an example of generating a metadata control for data processing is shown. Initially, at T₁, guided expression editor 206 retrieves from metadata repository 214 a list of BDEs 350 that can be used (e.g., as source values) in generating a control. For example, guided expression editor 206 can query the metadata model stored in the metadata repository 214 for all BDE nodes to retrieve the list of BDEs 350. In this example, the list of BDEs 350 includes “Contract Start Date” and “Contract End Date.” At T₂, guided expression editor 206 generates user interface (UI) data 352 based in part on the BDEs 350 and transmits the UI data 352 to development environment 218. Development environment 218 uses the UI data 352 to render a graphical user interface (GUI) 354 that enables a user to select one or more items of metadata (e.g., a BDE) and guides a user through a series of selections to specify one or more conditions, rules, or other logic with respect to the selected item(s) of metadata, thereby generating the metadata control.

GUI 354 includes a first portion 354a that enables a user to select a BDE from the list of BDEs 350 to be used as a source value or parameter in the control. In this example, the BDE “Contract Start Date” is selected (at T₃) as the source value, as shown by the checkmark in portion 354a. GUI 354 also includes a second portion 354b that enables a user to select an operator from a set of operators to be applied to the source value. In some examples, the set of operators presented in portion 354b is selected based on the particular source value selected in portion 354a. In this example, the operator “is less than” is selected (at T₃), as shown by the checkmark in portion 354b.

At T₄, development environment 218 transmits selection data 356 specifying the selected source value (e.g., “Contract Start Date”) and the selected operator (e.g., “is less than”) to the guided expression editor 206. In response, guided expression editor 206 determines, based on the selection data 356, one or more additional values (e.g., BDEs) and/or operators, if any, that can be used in generating the control. For example, guided expression editor 206 can query the metadata repository 214 (e.g., the metadata model) for additional values and/or operators based on the selection data 356. At T₅, guided expression editor 206 generates additional UI data 358 based in part on the determined additional values and/or operators and transmits the UI data 358 to development environment 218. Development environment 218 uses the UI data 358 to render an updated GUI 354′. Updated GUI 354′ includes a third portion 354c that enables a user to select a second BDE to be used in the control. In this example, the BDE “Contract End Date” is selected (at T₆), as shown by the checkmark in portion 354c. Once the control definition is complete, a user interface element 360 can be selected to approve the control definition and transmit (at T₇) additional selection data 362 specifying the selections. In some examples, the control definition can be tested against data before approval to determine whether the control is working as intended. Through the GUIs 354, 354′, guided expression editor 206 guides a user in defining a control at a logical level (BDE level) without the need for the user to understand or access the underlying data, and without requiring the user to write code (e.g., by presenting valid choices for defining the control, rather than requiring the user to write or edit the control's underlying code), thereby avoiding syntax errors.

At T₈, guided expression editor 206 transmits control data 364 specifying the control definition (e.g., “Contract Start Date is less than Contract End Date,” according to selections 356, 362) to control generator 208. In response, control generator 208 generates control data 366 (which may be the same or different from control data 364) that includes instructions to add the control to metadata model 302′. For example, control data 366 can include instructions to add node 368 to metadata model 302′ representing the control “Contract Start Date<Contract End Date.” Control data 366 can also include instructions to add edges (e.g., references, pointers, etc.) linking node 368 to nodes 310a, 310b representing the BDEs “Contract Start Date” and “Contract End Date.” By updating the metadata model 302′ in this way, the control represented by node 368 can automatically be applied in a top-down manner to any new or existing data that is linked to the BDE “Contract Start Date” and/or the BDE “Contract End Date.”

Although a particular process for defining a metadata control using guided expression editor 206 is described with reference to FIG. 3B, alternative techniques for defining a control can be used in some examples.

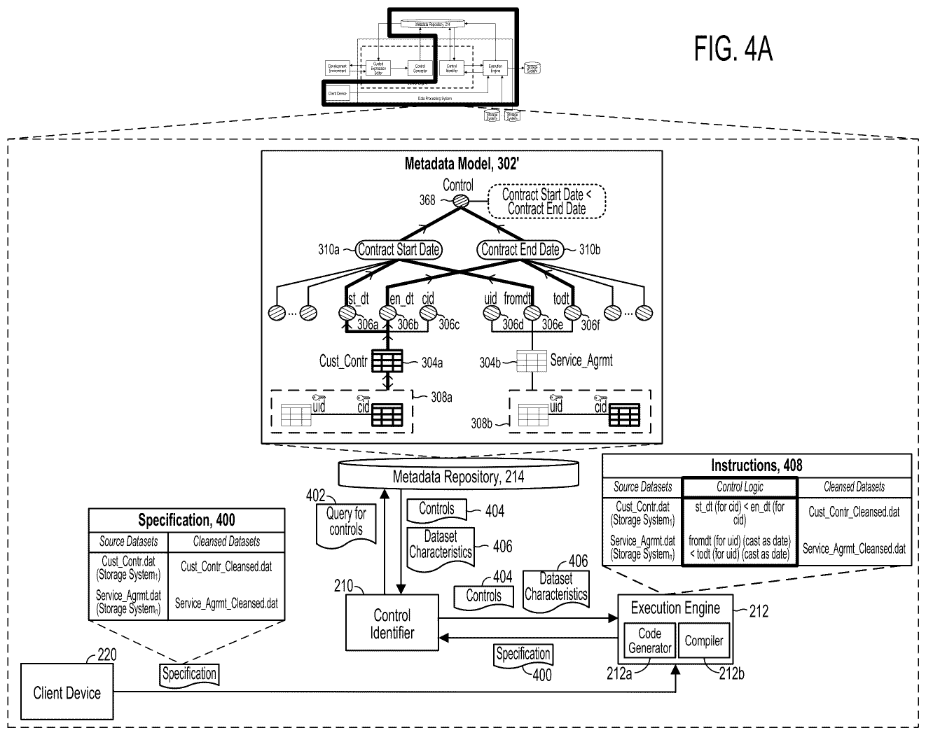

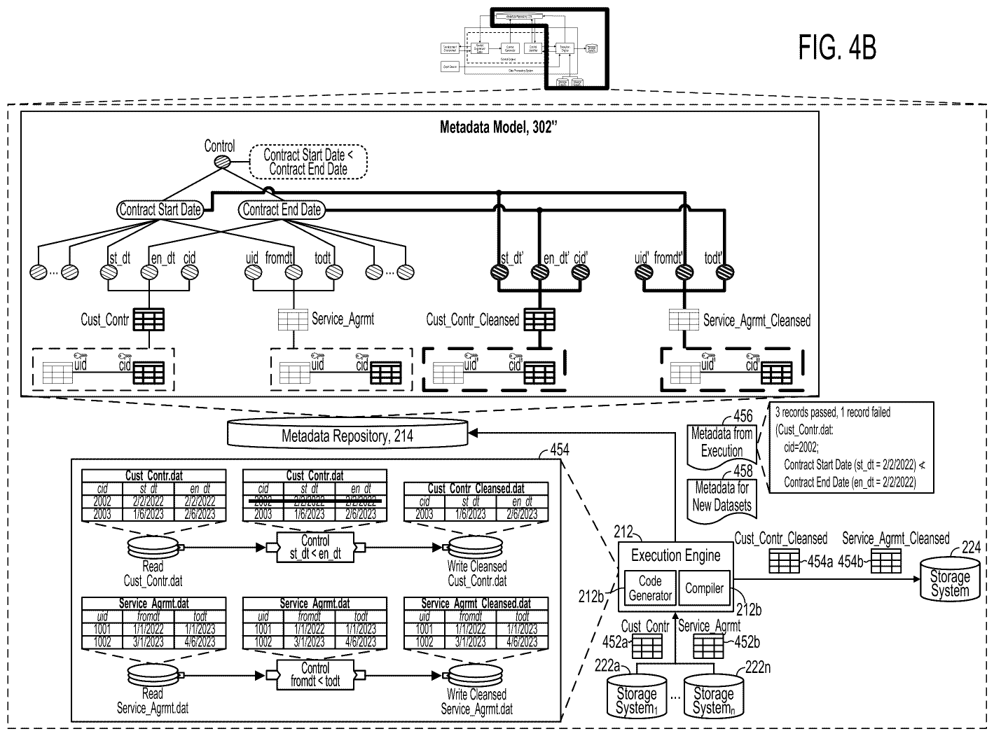

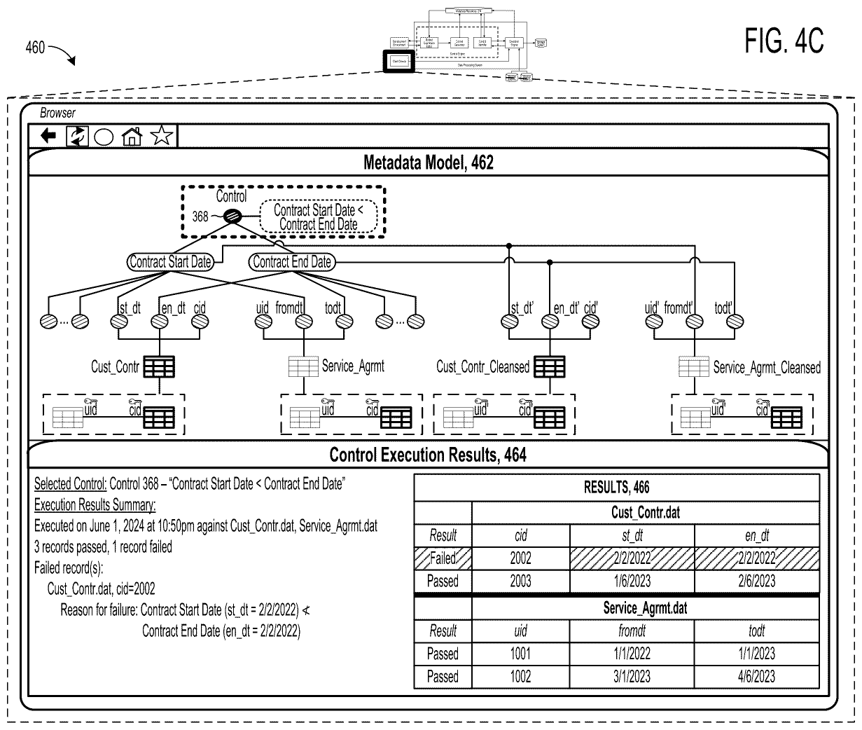

Referring to FIG. 4A, an example of applying a metadata control for data processing is shown. In this example, client device 220 transmits a specification 400 to execution engine 212. The specification 400 can be transmitted in response to user input, at (pre-) determined times, or in response to various triggering events, such as changes to the metadata model 302′. Generally, the specification 400 includes instructions for generating and/or executing a computer program (e.g., a dataflow graph) to perform operations on data. For example, the specification 400 can include instructions to access data from one or more source systems, optionally transform the data, and store the (transformed) data in one or more destination systems. In this example, the specification 400 includes instructions to access the “Cust_Contr” dataset from storage system 222a and the “Service_Agrmt” dataset from storage system 222n, and store governed (e.g., cleansed and conformed) versions of these datasets in storage system 224 (e.g., as “Cust_Contr_Cleansed” and “Service_Agrmt_Cleansed”). In some examples, the specification 400 can be a pipeline object that includes a data object or other data structure specifying actions to be performed in ingesting data, such as described in U.S. application Ser. No. 18/496,543, titled “Metadata Driven Data Ingestion and Data Processing,” the entire content of which is incorporated herein by reference.

Upon receipt of the specification 400, execution engine 212 transmits the specification 400 to control identifier 210 with a request for applicable controls. The request for applicable controls can also include a request for characteristics of the data to which the controls are to be applied. To identify the controls and characteristics applicable to the specification 400, control identifier 210 identifies the items of data that are to be processed in accordance with the specification. For example, control identifier 210 can parse the specification 400 to extract technical metadata (e.g., dataset names, field names, etc.) representing the items of data that are to be accessed or otherwise processed in accordance with the specification. Control identifier 210 can then send a query 402 to metadata repository 214 for controls and characteristics associated with the extracted technical metadata. For example, the query 402 can include a request for controls associated with the “Cust_Contr” and “Service_Agrmt” datasets. In another example, the query 402 can include a request for controls associated with the “cid,” “st_dt,” and “en_dt” fields of the “Cust_Contr” dataset, and with the “uid,” “fromdt,” and “todt” fields of the “Service_Agrmt” dataset.

In response to the query 402, the metadata model 302′ is traversed to determine the controls and characteristics that are applicable to the items of data to be processed in accordance with the specification 400. To do so, a data processing system (e.g., the data processing system 202 or another data processing system associated with the metadata repository 214) can first access node 304a representing the dataset “Cust_Contr.” Accessing the node 304a can include, for example accessing from hardware storage a data object or data structure that the node represents. Next, the edges associated with dataset node 304a can be followed to identify related nodes, such as the dataset characteristics node 308a. For example, dataset node 304a (or a separate edge data structure or object referenced by dataset node 304a) may include references to dataset characteristics node 308a, such as by including a unique identifier for dataset characteristics node 308a. In this case, following the edges can include identifying and accessing the dataset characteristics node 308a associated with the respective reference (e.g., unique identifier). In some examples, such as when the metadata model 302′ and its nodes are loaded into memory, dataset node 304a can include pointers to memory locations (e.g., memory addresses) for dataset characteristics node 308a, and following the edges can include accessing the dataset characteristics node 308a at the specified memory location.

Once the dataset characteristics node 308a is accessed, the metadata stored in the dataset characteristics node 308a can be read to obtain the characteristics for the corresponding dataset (e.g., “Cust_Contr”) and its TDEs. In some examples, the dataset characteristics node 308a can specify a definition (or specify characteristics used to create a definition) of an expanded view dataset that includes “Cust_Contr” (as the base dataset) and “Service_Agrmt” (as a related dataset). For example, the dataset characteristics node 308a can include instructions for creating an expanded view dataset (e.g., a wide record) by joining “Cust_Contr” and “Service_Agrmt” using the keys “cid” and “uid.” In this way, the dataset characteristics node 308a provides logical access to characteristics, such as data types and intra- and inter-dataset relationships, for the “Cust_Contr” dataset, its related dataset(s) (e.g., “Service_Agrmt”), and their TDEs. These characteristics enable controls defined with respect to one or more BDEs to be resolved (e.g., transformed into executable instructions) in a way that accounts for the characteristics of datasets and TDEs, thereby ensuring that the top-level controls accurately execute against the physical-level data.

After obtaining the characteristics from node 308a, edges associated with dataset node 304a can be followed to identify the linked TDE nodes 306a, 306b, and 306c. For example, dataset node 304a (or a separate edge data structure or object referenced by dataset node 304a) may include references to TDE nodes 306a, 306b, and 306c, such as by including unique identifiers for each of TDE nodes 306a, 306b, 306c. In this case, following the edges can include identifying and accessing the TDE nodes 306a, 306b, and 306c associated with the respective references (e.g., unique identifiers). In some examples, such as when the metadata model 302′ and its nodes are loaded into memory, dataset node 304a can include pointers to memory locations (e.g., memory addresses) for each of TDE nodes 306a, 306b, 306c, and following the edges can include accessing the TDE nodes 306a, 306b, 306c at the specified memory locations.

Similar processes can be followed to traverse other nodes in the metadata model 302′ and identify the applicable controls and characteristics. For example, the edge associated with TDE node 306a can be followed to identify and access BDE node 310a (e.g., “Contract Start Date”). From here, the edge associated with the BDE node 310a is followed to control node 368. Upon reaching control node 368, the data processing system determines that the associated control (e.g., “Contract Start Date<Contract End Date”) is applicable to the items of data to be processed in accordance with the specification 400. This control is also identified through traversal of the “Cust_Contr”-“en_dt”-“Contract End Date,” “Service_Agrmt”-“fromdt”-“Contract Start Date,” and “Service_Agrmt”-“todt”-“Contract End Date” paths of metadata model 302′, as shown by the bolded lines with arrows. As a result, controls data 404 specifying that the control “Contract Start Date<Contract End Date” is to be applied to TDEs “st_dt,” “en_dt,” “fromdt,” and “todt,” and dataset characteristics 406 including the characteristics (e.g., data types, relationships, etc.) of, for example, “st_dt,” “en_dt,” “fromdt,” and “todt” are returned to control identifier 210 in response to the query 402. In turn, control identifier 210 transmits the controls data 404 and dataset characteristics 406 to execution engine 212.

Although a particular example of traversing metadata model 302′ is described with respect to FIG. 4A, other means of traversal are also possible. For instance, in some examples, query 402 can be an entity query, such as described in U.S. Pat. No. 11,921,710, titled “Systems and methods for accessing data entities managed by a data processing system,” the entire content of which is incorporated herein by reference. In this example, execution of the entity query 402 can effectively traverse the metadata model 302′ to identify the relevant controls and characteristics such that the results of query 402 include the controls data 404 and dataset characteristics 406.

Using the specification 400, the controls data 404, and dataset characteristics 406, the execution engine 212 generates instructions 408. For example, the execution engine 212 can include a code generator 212a that uses a plurality of stored modules (e.g., dataflow graph components or other software components) to transform the specification 400, the controls data 404, and/or the dataset characteristics 406 into the instructions 408. For instance, in this example, the code generator 212a of the execution engine 212 can generate instructions 408 (e.g., code) to access data from each of “Cust_Contr” and “Service_Agrmt.” To do so, the code generator 212a may use one or more stored modules (e.g., dataflow graph components or other software components) specifying instructions to access data, and may supplement these instructions based on the specification 400, the controls data 404, and/or dataset characteristics 406 to access data from each of “Cust_Contr” and “Service_Agrmt” datasets.

The code generator 212a of the execution engine 212 can then generate instructions 408 to implement the control specified in control data 404 (e.g., “Contract Start Date<Contract End Date”) on the accessed data. For example, because dataset characteristics 406 specifies that the “st_dt” field representing “Contract Start Date” is related to or correlated with the “en_dt” field representing “Contract End Date” via the key field “cid,” code generator 212a generates instructions 408 to compare values of “st_dt” with values of “en_dt” on “cid” (as opposed to, e.g., comparing “st_dt” with “todt,” which also represents “Contract End Date”). In addition, because dataset characteristics 406 specifies that values of each of the “st_dt” and “en_dt” fields are of the date data type, code generator 212a generates instructions 408 to compare “st_dt” and “en_dt” using the less than operator without further transformation (e.g., without casting the data). In this example, the control is specified as a preventative control in which data that does not satisfy the criteria or condition “Contract Start Date<Contract End Date” is rejected. Accordingly, code generator 212a generates instructions 408 to reject any records having a value in the “st_dt” field that is less than a corresponding value in the “en_dt” field in the “Cust_Contr” dataset.

Similarly, because dataset characteristics 406 specifies that the “fromdt” field representing “Contract Start Date” is related to or correlated with the “todt” field representing “Contract End Date” via the key field “uid,” code generator 212a generates instructions 408 to compare values of “fromdt” with values of “todt” on “cid” (as opposed to, e.g., comparing “fromdt” with “en_dt,” which also represents “Contract End Date”). In addition, because dataset characteristics 406 specifies that values of each of the “fromdt” and “todt” fields are of the string data type, code generator 212a determines to transform values of “fromdt” and “todt” to, e.g., date data types before comparison using the less than operator, as comparing strings with the less than operator may produce unintended results. Accordingly, code generator 212a generates instructions 408 to cast “fromdt” and “todt” as dates, and then reject any records having a value in the “fromdt” field that is less than a corresponding value in the “todt” field in the “Service_Agrmt” dataset.

Code generator 212a also generates instructions 408 to write or store the datasets governed by the control as “Cust_Contr_Cleansed” and “Service_Agrmt_Cleansed.” To do so, code generator 212a may store one or more modules (e.g., dataflow graph components or other software components) specifying instructions to write data, and may supplement these instructions based on the specification 400 to write each of the generated “Cust_Contr_Cleansed” and “Service_Agrmt_Cleansed” datasets to a specified storage system. Additional details on operations performed by execution engine 212 in generating the instructions are described in U.S. Pat. No. 11,423,083, titled “Transforming a Specification into a Persistent Computer Program,” the entire content of which is incorporated herein by reference.

In some examples, a compiler 212b of the execution can transform (e.g., compile) the instructions 408 into executable instructions, such as an executable computer program (e.g., an executable dataflow graph). In some examples, an interpreter can be used instead of or in addition to the compiler 212b.

Referring to FIG. 4B, an example of applying a metadata control for data processing is shown. In this example, execution engine 212 executes the executable instructions (e.g., computer program) described with reference to FIG. 4A in order to ingest the “Cust_Contr” dataset 452a from storage system 222a and the “Service_Agrmt” dataset 452b from storage system 222n, process the datasets in accordance with the control, and store the resultant “Cust_Contr_Cleansed” dataset 452a and the “Service_Agrmt_Cleansed” dataset 452b to storage system 224. As shown in visualization 454, execution engine 212 first reads the “Cust_Contr” and “Service_Agrmt” datasets. Then, execution engine 212 checks whether “st_dt” is less than “en_dt” for each record in the “Cust_Contr” dataset, and whether “fromdt” (casted as a date) is less than “todt” (casted as a date) for each record in the “Service_Agrmt” dataset. In this example, the record associated with “cid” 2002 in the “Cust_Contr” dataset has failed the control, because the value of “st_dt” (2/2/2022) is not less than the value for “en_dt” (also Feb. 2, 2022). As a result, the failed record is rejected (e.g., removed) from the “Cust_Contr_Cleansed” dataset, though other actions can be taken in some examples. Once execution is complete, the “Cust_Contr_Cleansed” dataset 452a and the “Service_Agrmt_Cleansed” dataset 452b are stored in the storage system 224. In this manner, a single control defined at a logical level in the metadata model is automatically applied to multiple datasets from disparate sources and having different characteristics.

Execution engine 212 provides metadata 456 resulting from the execution to metadata repository 214 for storage. For example, the metadata 456 can be stored in or otherwise associated with the corresponding control node 368 in the metadata model 302″. In this example, the metadata 456 specifies that three records passed the control while one record failed, and further specifies the reason for the failure. This information can be displayed to a user to enable the user to understand the results of executing the control and identify records having data quality (or other) issues. In addition, this information can be used as the basis for further controls. For example, the control 368 (or another control linked to the control 368) can specify rules or logic that are conditioned upon the metadata 456 resulting from execution, such as a rule to send an alert to a designated user and/or cease execution of the control 368 in response to detecting a specified number of failed records. In some examples, metadata resulting from execution of a control is collected over time to derive statistics about execution of the control (e.g., total number of failed records, average percent of failed records, etc.). This cumulative or statistical information can be used as the basis for further controls, such as the anomaly detection controls described herein.

Execution engine 212 also provides metadata 458 for the new datasets “Cust_Contr_Cleansed” and “Service_Agrmt_Cleansed” to metadata repository 214. Based on the metadata 458, metadata model 302″ is updated to include nodes representing the new datasets, their fields, and their characteristics, as well as edges linking the nodes, as shown by the bolded portions of metadata model 302″. In this example, the new nodes representing TDEs of the new datasets are linked (e.g., via edges) to existing BDEs that represent the semantic meaning of the TDEs. By updating the metadata model 302″ in this way, new datasets (e.g., “Cust_Contr_Cleansed” and “Service_Agrmt_Cleansed”) will continue to be governed in accordance with the specified controls without the need to define new controls for the new datasets.

Referring to FIG. 4C, an example interface 460 visualizing the results of applying metadata controls is shown. In this example, interface 460 includes a metadata model portion 462 that visualizes a version of the metadata model (e.g., the metadata model 302″). A user can interact with the metadata model portion 462 to select one or more nodes of the metadata model in order to view further details about the execution of controls associated with the selected node(s), among other information. In this example, a user selects control node 368. Upon selection of the control node 368, results of execution of the control node 368 are shown in a control execution results portion 464 of the interface 460. In this example, control execution results portion 464 includes an execution results summary that provides information about the execution of control 368, such as the time of execution, the number of records that passed the control, the number of records that failed the control, and a reason for failure for applicable records. Control execution results portion 364 can also include a results table 466 that enables a user to view the results of executing the control 368 on a record-by-record basis. In this example, the results table 466 identifies (e.g., through highlighting or another indicator) the records that failed the control 368.

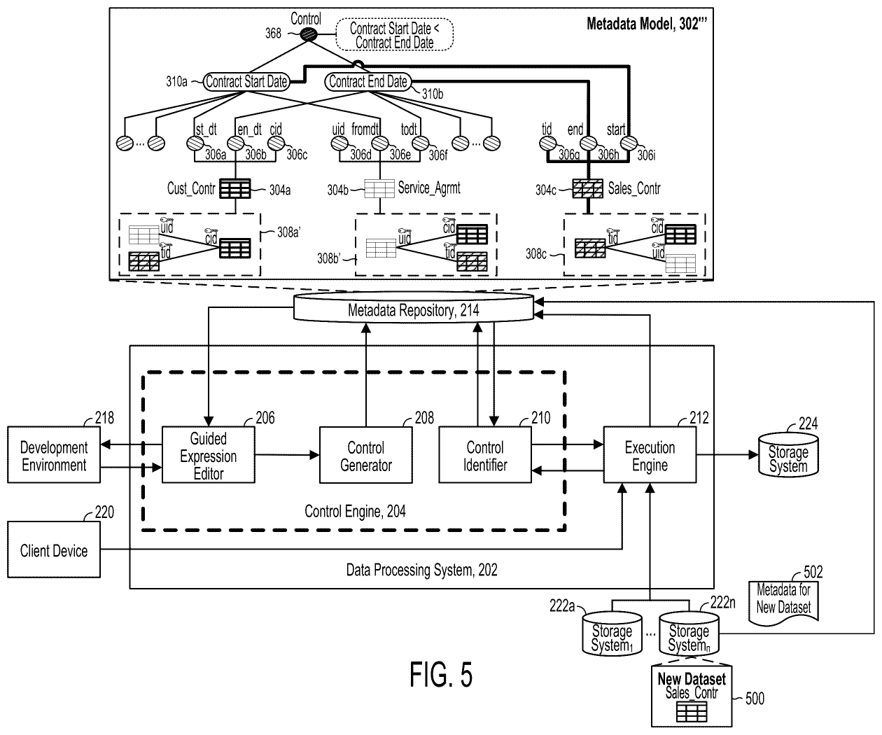

Referring to FIG. 5, an example of applying metadata controls to new data is shown. In this example, a new dataset “Sales_Contr” 500 is added to storage system 222n, and metadata 502 for the new dataset (which can be discovered as described herein) is provided to the metadata repository 214. In response, the metadata model 302′″ is updated to incorporate the new dataset, as shown by the bolded portions of metadata model 302′″. For example, metadata model 302′″ can be updated with a dataset node 304c representing the “Sales_Contr” dataset, and TDE nodes 306g, 306h, 306i representing the “tid,” “end,” and “start” fields of the “Sales_Contr” dataset, respectively. The metadata model 302′″ is also updated with edges to link dataset node 304c and TDE nodes 306g, 306h, 306i to indicate that the “cid,” “end,” and “start” are TDEs (e.g., fields) of the “Sales_Contr” dataset.

Metadata model 302′″ is also updated with node 308c specifying characteristics of the dataset “Sales_Contr” corresponding to node 304c and its TDEs corresponding to nodes 306g-306i. For example, node 308c can specify that the “tid” field serves as a primary key for dataset “Sales_Contr” and the “end” and “start” fields within the dataset “Sales_Contr.” In other words, node 308c specifies that values of the “tid” field uniquely identify records containing values for the fields (e.g., “st_dt” and “en_dt”) within the dataset “Cust_Contr.” In some examples, node 308c specifies a definition of an expanded view dataset that includes “Sales_Contr” (as the base dataset and “Cust_Contr” and “Service_Agrmt” (as related datasets). For example, node 308c can specify that the “Sales_Contr” and “Cust_Contr” datasets are related to one another according to a primary-foreign key relationship, with the “tid” field in “Sales_Contr” serving as the primary key and the “cid” field in “Cust_Contr” serving as the foreign key. In addition, node 308c can specify that the “Sales_Contr” and “Service_Agrmt” datasets are related to one another according to a primary-foreign key relationship, with the “tid” field in “Sales_Contr” serving as the primary key and the “uid” field in “Service_Agrmt” serving as the foreign key. Node 308c can also include logic for joining “Sales_Contr,” “Cust_Contr,” and “Service_Agrmt” based on the primary-foreign key relationships. In some examples, node 308c can also include characteristics for datasets related to “Sales_Contr” (e.g., “Cust_Contr” and “Service_Agrmt”) and their TDEs. Metadata model 302′″ can also be updated to include nodes 308a′ and 308b′ that include the relationship between “Sales_Contr” and each of “Cust_Contr” and “Service_Agrmt.”

In this example, metadata model 302′″ is also updated to include edges linking the TDE nodes 306g, 306h, and 306i representing items of technical metadata for the new dataset 500 to BDE nodes 310a, 310b that specify a semantic meaning for the TDEs. For example, semantic discovery processes can be performed as described herein to determine the semantic meaning of fields corresponding to TDE nodes 306g, 306h, and 306i. In this example, it is determined via semantic discovery that the “start” field of the “Sales_Contr” dataset represents a “Contract Start Date.” As such, an edge is added to metadata model 302′″ to link the TDE node 306i with BDE node 310a through the characteristics node 308i. Similarly, it is determined that the “end” field of the “Sales_Contr” dataset represents a “Contract End Date.” As such, an edge is added to metadata model 302′″ to link the TDE node 306h with BDE node 310b through the characteristics node 308h. By updating the metadata model 302′″ in this way, the new dataset 500 is now associated with the control node 368 in the metadata model. As a result, the control can automatically be applied to the new dataset 500, without the need for manual user intervention to define new control logic for dataset 500.

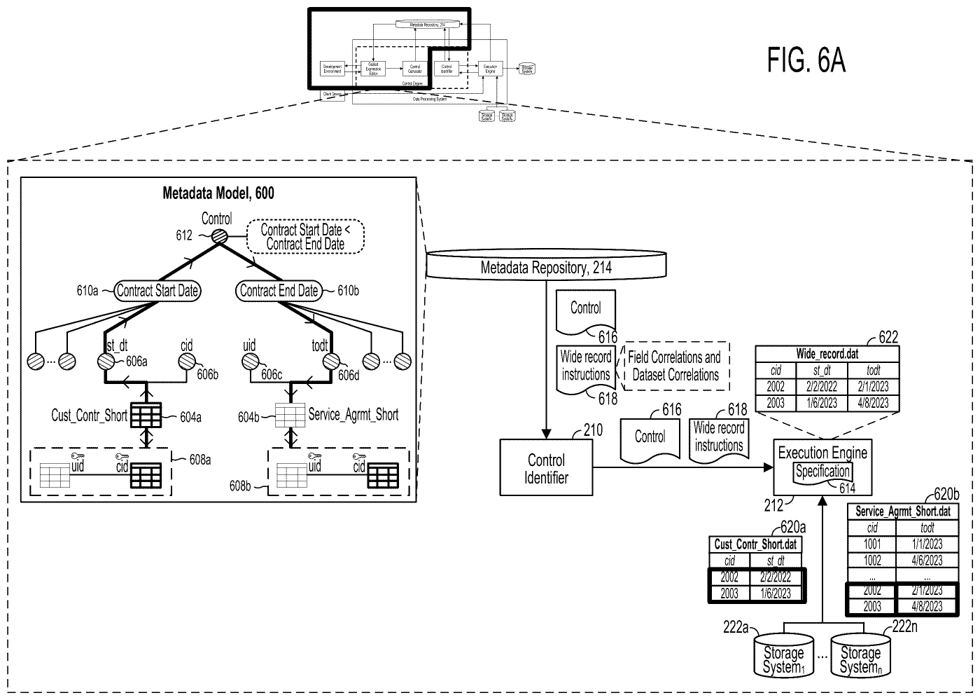

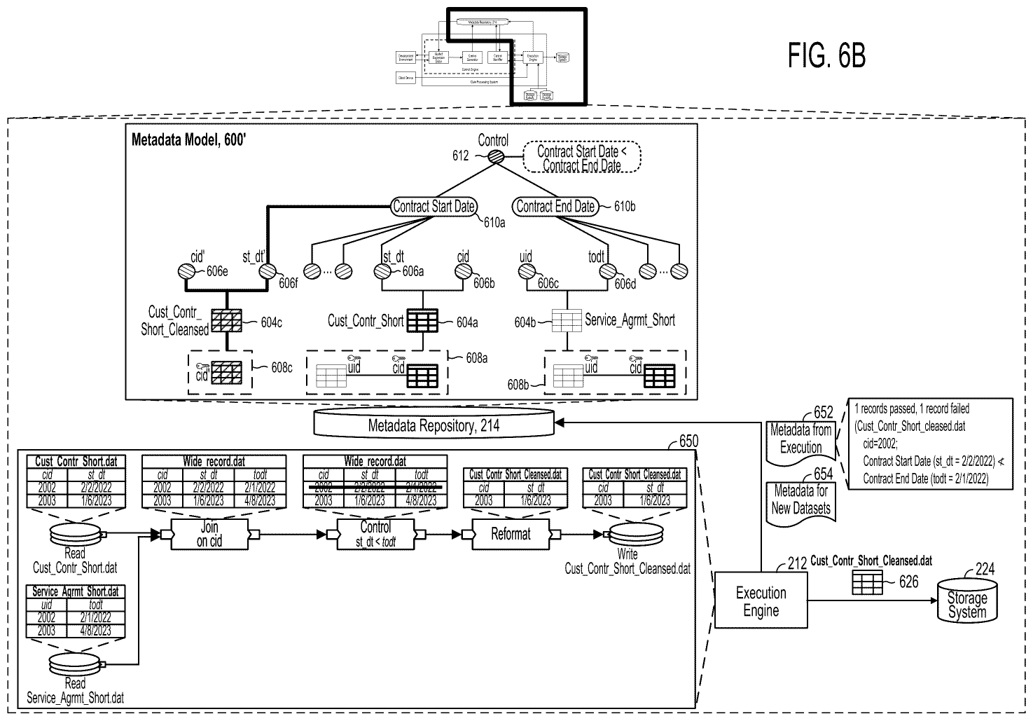

Referring to FIG. 6A, an example of applying metadata controls across multiple datasets is shown. In this example, metadata repository 214 stores a metadata model 600. Metadata model 600 includes a node 604a specifying metadata for a dataset “Cust_Contr_Short” (similar to “Cust_Contr” represented in metadata model 302) and a node 604b specifying metadata for a dataset “Service_Agrmt_Short” (similar to “Service_Agrmt” represented in metadata model 302). However, unlike the datasets “Cust_Contr” and “Service_Agrmt” in metadata model 302 that each included TDEs for both “Contract End Date” and “Contract End Date” in a single dataset, the TDEs for “Contract Start Date” and “Contract End Date” are spread across datasets “Cust_Contr” and “Service_Agrmt” in metadata model 600. As such, the control “Contract Start Date<Contract End Date” that was evaluated within a single dataset in the examples of FIGS. 4A and 4B now requires evaluation across multiple datasets.

More specifically, metadata model 600 includes nodes 606a, 606b specifying metadata (e.g., field names) for TDEs “st_dt” and “cid” that are part of dataset “Cust_Contr_Short,” and nodes 606c, 606d specifying metadata for TDEs “uid” and “todt” that are part of dataset “Service_Agrmt_Short.” Metadata model 600 also includes a node 610a specifying metadata for a BDE “Contract Start Date,” and a node 610b specifying metadata for a BDE “Contract End Date.” In this example, BDE node 610a (“Contract Start Date”) describes or gives meaning to TDE node 606a (“st_dt”), and BDE node 610b (“Contract End Date”) describes or gives meaning to TDE node 606d (“todt”). Thus, in order to evaluate the control “Contract Start Date<Contract End Date” specified by the control node 612, data from multiple datasets must be accessed and compared.

To enable evaluation of a control across multiple datasets, metadata model 600 includes nodes 608a, 608b specifying correlations among datasets and fields, among other characteristics. For example, nodes 608a, 608b specify a dataset correlation between the datasets “Cust_Contr_Short” and “Service_Agrmt_Short” corresponding to nodes 604a, 604b (as well as their TDEs). Dataset correlation can specify, for example, a primary-foreign key relationship between datasets “Cust_Contr_Short” and “Service_Agrmt_Short,” such as by specifying that the “cid” field serves as a primary key for the dataset “Cust_Contr_Short” that relates to foreign key field “uid” in “Service_Agrmt_Short” (and vice versa, where “uid” is the primary key and “cid” is the foreign key). In this example, dataset correlation includes instructions for generating a wide record (or an expanded view dataset) that includes the data from a base dataset (e.g., one of “Cust_Contr_Short” and “Service_Agrmt_Short”) and related datasets (e.g., the other of “Cust_Contr_Short” and “Service_Agrmt_Short”). Such instructions can specify how to join the “Cust_Contr_Short” and “Service_Agrmt_Short” datasets based on their primary-foreign key relationship.

Node 608a can also specify a field correlation between TDEs “st_dt” and “cid” corresponding to nodes 606a, 606b. In other words, node 608a specifies that the “cid” field serves as a primary key for the “st_dt” field within the dataset “Cust_Contr_Short” such that values of the “cid” field uniquely identify records containing values for the “st_dt” field. Node 608b can specify a field correlation between TDEs “uid” and “todt” corresponding to nodes 606c, 606d. In other words, node 608b can specify, for example, that the “uid” field serves as a primary key for the “todt” field within the dataset “Service_Agrmt_Short” such that values of the “uid” field uniquely identify records containing values for the “todt” field. In some examples, metadata model 600 can also include other characteristics for the datasets and TDEs, such as record format or data type (not shown).

In this example, execution engine 212 receives a specification 614 that includes instructions to access the “Cust_Contr_Short” dataset from storage system 222a, and store a governed (e.g., cleansed and conformed) version of this dataset in storage system 224 (e.g., as “Cust_Contr_Short_Cleansed”). Upon receipt of the specification 614, execution engine 212 transmits the specification to control identifier 210 with a request for applicable controls (not shown). In response, the metadata model 600 is traversed to determine the controls and characteristics that are applicable to the items of data to be processed in accordance with the specification 614. To do so, a data processing system (e.g., the data processing system 202 or another data processing system associated with the metadata repository 214) can first access node 604a representing the dataset “Cust_Contr_Short.” Next, the edges associated with dataset node 604a can be followed to identify and access the linked dataset characteristics node 608a to collect characteristics (e.g., field and dataset correlations) for use in applying any applicable controls. Similar processes can be followed to traverse other nodes in the metadata model 600 and identify the applicable controls. For example, the edges associated with dataset node 604a can be followed to identify and access TDE nodes 606a, 606b. Once at TDE nodes 606a, 606b, the edge associated with TDE node 606a can be followed to identify and access BDE node 610a (e.g., “Contract Start Date”). From here, the edge associated with the BDE node 610a is followed to control node 612.

Upon reaching control node 612, the data processing system determines that the associated control (e.g., “Contract Start Date<Contract End Date”) is applicable to the items of data to be processed in accordance with the specification. The data processing system also determines that a “Contract End Date” that corresponds to the identified “Contract Start Date” (e.g., “st_dt” of “Cust_Contr_Short”) is needed to evaluate the control. In some examples, the data processing system determines, based on the characteristics obtained from dataset characteristics node 608a, that “todt” of “Service_Agrmt_Short” corresponds to (e.g., correlates to) “st_dt” of “Cust_Contr_Short.” Accordingly, the data processing system traverses back down the metadata model 600 along the “Contract End Date”-“todt”-“Service_Agrmt_Short” path, as shown by the bolded lines with arrows. Through this traversal, the “Contract End Date” (e.g., “todt” of “Service_Agrmt_Short”) that corresponds to the identified “Contract Start Date” (e.g., “st_dt” of “Cust_Contr_Short”) is identified and accessed. As a result, controls data 616 specifies that the control “Contract Start Date<Contract End Date” is to be applied to TDEs “st_dt” of “Cust_Contr_Short” and “todt” of “Service_Agrmt_Short,” and wide record instructions 618 including the identified dataset and field correlations and instructions for generating a wide record that includes the data from “Cust_Contr_Short” and “Service_Agrmt_Short” are returned to control identifier 210. In turn, control identifier 210 transmits the controls data 616 and the wide record instructions 618 to execution engine 212.

Using the specification 614, the controls data 616, and the wide record instructions 618, execution engine 212 generates executable instructions to access the “Cust_Contr_Short” dataset 620a, implement the control “Contract Start Date<Contract End Date”, and store a governed version of this dataset in storage system 224 (e.g., as “Cust_Contr_Short_Cleansed”). Because the control is evaluated across multiple datasets in this example, execution engine 212 uses wide record instructions 618 for generating executable instructions to access both the “Cust_Contr_Short” dataset 620a and the “Cust_Contr_Short” dataset 620b and join records of the datasets 620a, 620b where the value of the primary key “cid” matches the value of the foreign key “uid,” thereby creating a temporary wide record 622 that includes the data needed to evaluate the control. In this example, the bolded records of “Cust_Contr_Short” dataset 620a and the “Service_Agrmt_Short” dataset 620b have matching key values “2002” and “2003” that are joined to produce the wide record 622 when the instructions are executed. Execution engine 212 also generates instructions to write or store the dataset governed by the control as “Cust_Contr_Cleansed.”

Referring to FIG. 6B, an example of applying a metadata control to multiple datasets is shown. In this example, execution engine 212 executes the executable instructions (e.g., computer program) described with reference to FIG. 6A in order to ingest the “Cust_Contr_Short” dataset 620a and the “Service_Agrmt_Short” dataset 620b, join the two datasets to generate a temporary wide record, process the wide record in accordance with the control, reformat the wide record to produce a governed “Cust_Contr_Short_Cleansed” dataset 626 that includes the same record format as the “Cust_Contr_Short” dataset, and store the “Cust_Contr_Short_Cleansed” dataset 626 to storage system 224. As shown in the visualization 650, execution engine 212 first reads the “Cust_Contr_Short” and “Service_Agrmt_Short” datasets. Then, execution engine 212 joins the two datasets on matching values of “cid” and “uid” to produce a temporary wide record (e.g., “Wide_record.dat”). Execution engine 212 checks whether “st_dt” is less than “todt” for each record in the wide record dataset. In this example, the record associated with “cid” value 2002 has failed the control, because the value of “st_dt” (2/2/2022) is not less than the value for “todt” (2/1/2022). As a result, the failed record is rejected (e.g., removed) from the wide record dataset, though other actions can be taken in some examples. After applying the control, execution engine 212 reformats the wide record to produce a “Cust_Contr_Short_Cleansed” dataset having the same record format as the original “Cust_Contr_Short” dataset (e.g., by dropping the “todt” field from the wide record). Execution engine 212 then stores “Cust_Contr_Short_Cleansed” in the storage system 224. In this manner, a control defined at a logical level in the metadata model is automatically applied across multiple disparate datasets.

Execution engine 212 provides metadata 652 resulting from the execution to metadata repository 214 for storage. For example, the metadata 652 can be stored in or otherwise associated with the corresponding control node 612 in the metadata model 602′. In this example, the metadata 652 specifies that three records passed the control while one record failed, and further specifies the reason for the failure. This information can be displayed to a user, trigger further actions (e.g., alerts), and/or used to derive statistical insights for further controls, such as anomaly detection controls.

Execution engine 212 also provides metadata 654 for the new dataset “Cust_Contr_Short_Cleansed” to metadata repository 214. Based on the metadata 654, metadata model 600′ is updated to include a node 604c representing the new dataset, nodes fields 606e, 606f representing its fields, and node 608c representing its characteristics, as well as edges linking the nodes, as shown by the bolded portions of metadata model 600′. In this example, the new node 606f representing the TDE “st_dt′” of the new dataset is linked (e.g., via an edge) to existing node 610a of the BDE “Contract Start Date” that represents the semantic meaning of the TDE “st_dt′.” By updating the metadata model 600′ in this way, new datasets (e.g., “Cust_Contr_Short_Cleansed”) will continue to be governed in accordance with the specified controls without the need to define new controls for the new datasets.

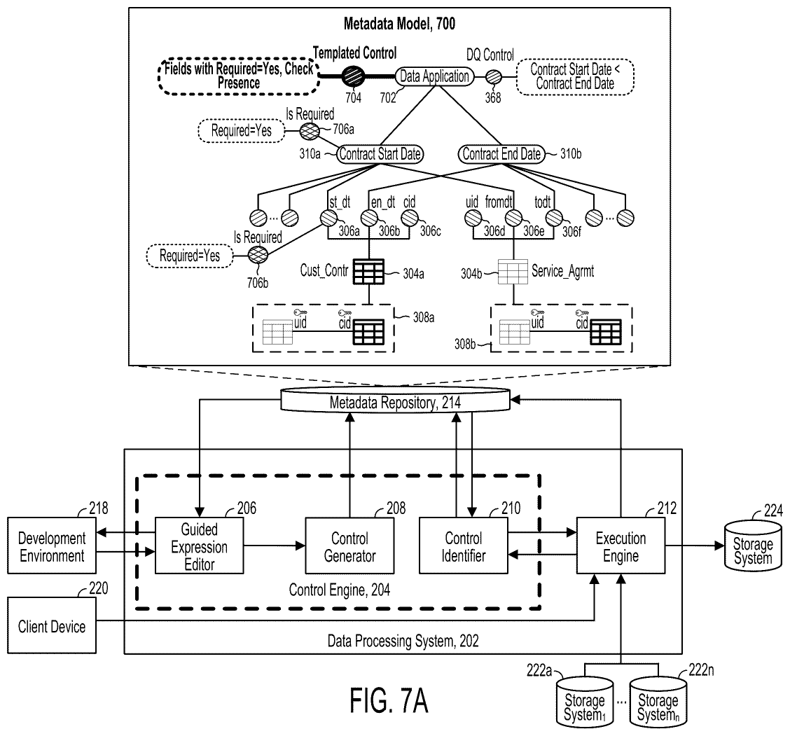

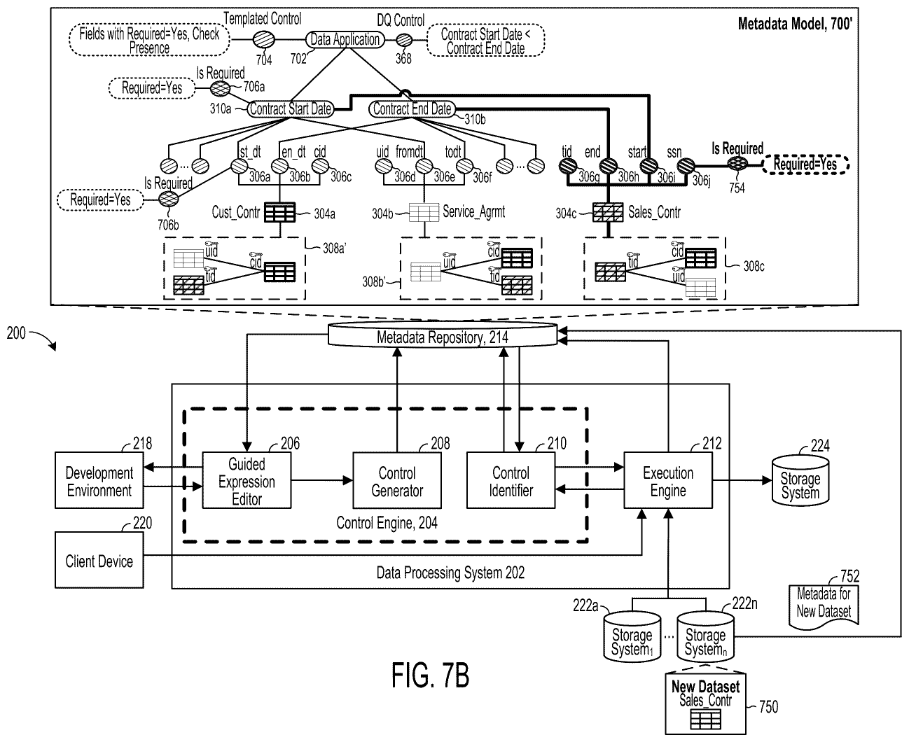

Referring to FIG. 7A, an example of a templated control is shown. In this example, a metadata model 700 includes an application node 702 that specifies an application or data domain (e.g., Data Application) used to group BDEs (e.g., BDEs 310a, 310b) and other metadata. Metadata model 700 also includes a templated control node 704 that specifies to check presence for fields with required=yes. That is, templated control node 704 specifies that if data (e.g., a TDE, a BDE, and so forth) is marked as required (e.g., Required=Yes), then a check should be performed to check that a value is present. These types of controls are referred to as templated controls because the control is written independently of any particular data element or other data item. These controls are templated because, once data is identified that satisfies a given requirement (e.g., Required=Yes), then the control is applied to that data. These templated controls are also referred to as bulk controls because they are controls that are applied to many different types of data—and hence are applied in bulk.

In this example, templated control node 704 is linked (via an edge) to data application node 702, meaning that the templated control 704 applies to items of metadata grouped within the data application node 702 in the metadata model 700. Metadata model 700 also includes a node 706a specifying that the BDE node 310a representing “Contract Start Date” is a required field, and a node 706b specifying that the TDE node 306a corresponding to “st_dt” is a required field. In some examples, the metadata specified by nodes 706a, 706b can be incorporated into nodes 310a, 306a, respectively.

In operation, upon receiving instructions (e.g., a specification) to process data, execution engine 212 transmits a request to control identifier 210 for applicable templated (and other) controls. In response to the request, metadata model 700 is traversed to identify which templated controls to apply to data to be processed in accordance with the specification (e.g., as represented by technical metadata in the specification). In an example, the dataset “Cust_Contr” represented by node 304a is to be processed in accordance with the specification. In this example, a data processing system accesses dataset node 304a representing “Cust_Contr,” and executes instructions to identify one or more other nodes that are linked to node 302a by an edge. In this example, the data processing system determines that dataset node 304a is linked to characteristics node 308a, and is also linked to TDE node 306a, which in turn is linked to BDE node 310a, which in turn is linked to application node 702, which in turn is linked to templated control node 704. As a result of this traversal, the data processing system determines that the templated control associated with node 704 is applicable to data associated with each of nodes 304a, 306a, 308a, 310a, and 702, among others. The data processing system also determines that TDE node 306a is a required field from traversal of the edge between node 306a and node 706b, and that BDE node 310a is a required field from traversal of the edge between node 310a and node 706a. As such, templated control data specifying the templated control (e.g., Fields with Required=Yes, Check Presence) and the items to which the templated control are applied (e.g., the TDE “st_dt” and BDE “Contract Start Date,” which are identified as required in metadata model 700) is returned to control identifier 210.

Execution engine 212 receives templated control data from control identifier 210 and generates instructions for application of the templated control to the data represented by “st_dt” and “Contract Start Date.” These instructions can include, for example, executable logic to check for the presence of data in the “st_dt” and “Contract Start Date” fields. Upon execution of these instructions, execution engine 212 accesses the “Cust_Contr” dataset and applies the control specified by the templated control node 704 to the “st_dt” field to check for the presence of a value in each record. Following application, execution engine 212 outputs a version of the “Cust_Contr” dataset in which the templated control has been applied, as well as other executable logic that execution engine 212 has been configured to apply. This dataset is stored in storage system 224. Using the techniques described herein, templated control is also applied to the data represented by BDE node 310a (e.g., to check that a name, description, and/or other attributes of the BDE are present).

In this example, execution engine 212 is programmed with one or more computation graphs to apply to the “Cust_Contr” dataset, is programmed with executable logic to apply to the “Cust_Contr” dataset, and so forth. As previously described, the instructions generated by execution engine 212 can include executable logic representing the control specified by templated control 704, thereby enabling execution engine 212 to apply the control specified by templated control 704. As shown in this example, templated control 704 is defined without reference to any particular dataset, item of data, or item of metadata. Rather, templated control 704 is defined with regard to metadata, namely, a control specifying required=yes. Then, at each level of the metadata model, a node can be associated with this metadata, which causes the templated control 704 to be applied to data represented by that node and/or data represented by one or more child nodes of that node.

In this example, templated control 704 includes a template portion and a control portion. The template portion includes a first condition to check whether a field is associated with required=yes. The control portion is or includes a second condition to check that that field is populated or to check the presence of data in that field. As such, templated control includes two conditions, neither of which are defined with regard to any particular item of data, any particular item of technical metadata, any particular item of logical metadata, and so forth. As such, templated control 704 allows for increased efficiency during data processing. This is because a templated control only needs to be defined once—for example, at a logical level. Once the templated control is defined, then it can be applied to all kinds of data represented in the metadata model. Additionally, templated control 704 can be applied to data received across multiple different data streams or data sources. This is because the metadata model itself can represent data from across multiple data sources and/or multiple data streams. In this manner, templated controls ensure enhanced data quality and ingestion or storage of datasets. Enhanced data quality results in more efficient data processing because the system does not need to process data that is formatted incorrectly or that has poor quality.

Referring to FIG. 7B, an example of applying a templated control to a new dataset is shown. In this example, a new dataset “Sales_Contr” 750 is added to storage system 222n, and metadata 752 for the new dataset (which can be discovered as described herein) is provided to the metadata repository 214. In response, the metadata model 700′ is updated to incorporate the new dataset, as shown by the bolded portions of metadata model 700′. For example, metadata model 700′ can be updated in a similar manner as described with reference to FIG. 5 to include a dataset node 304c representing the “Sales_Contr” dataset, and TDE nodes 306g, 306h, 3061, 306j representing the “tid,” “end,” “start,” and “ssn” fields of the “Sales_Contr” dataset, respectively. The metadata model 700′ is also updated with edges to link dataset node 304c and TDE nodes 306g, 306h, 3061, 306j to indicate that “cid,” “end,” “start,” and “ssn” are TDEs (e.g., fields) of the “Sales_Contr” dataset.

Metadata model 700′ is also updated with node 308c specifying characteristics (e.g., data types, record formats, relationships, etc.) of the “Sales_Contr” dataset and its TDEs. Dataset characteristics nodes 304a′, 304b′ are also updated to account for the new dataset. In this example, metadata model 800′ is also updated to include edges linking the TDE nodes 306h, 306i representing items of technical metadata for the new dataset 750 to BDE nodes 310a, 310b that specify a semantic meaning for the TDEs (e.g., as determined via semantic discovery processes).

Once the metadata model 700′ has been updated to account for the new dataset 750, the newly added nodes will automatically inherit templated controls from parent nodes that themselves have inherited the templated controls or for which templated controls have been defined. For example, templated control 704 can automatically be inherited or propagated down to new dataset 750 (represented by node 304c) and its associated TDEs (represented by nodes 306g, 306h, 306i, 306j). As such, if node 754 is added to metadata model 700′ to specify that TDE node 306j is a required field, the templated control 704 will automatically be applied to node 306j. This example highlights the efficiency of templated controls, because a templated control only needs to be defined once and can then automatically be applied to new ingested datasets. As such, templated controls promote efficient application of data quality controls, without these data quality controls having to be re-defined for each newly ingested or stored dataset. Additionally, the use of semantic discovery ensures that new nodes are correctly linked into the metadata model 700′. Incorrect linkages result in processing inefficiencies, as data quality controls (or rules) would then be applied to incorrect datasets. As such, the correct linkages result in increased processing efficiency through application of the data quality controls to the correct datasets. A data quality control is a type of templated control.

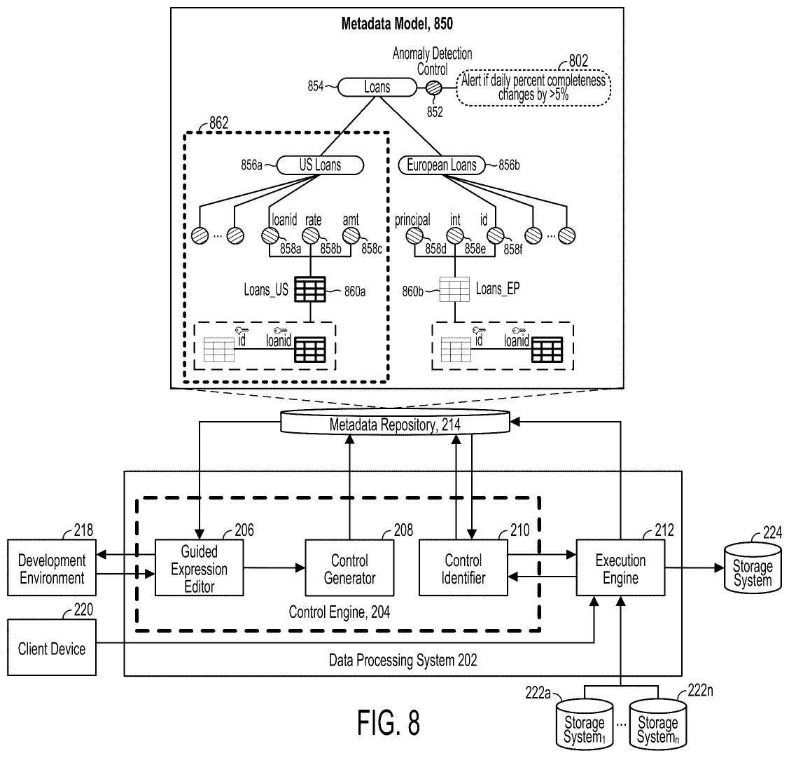

Referring to FIG. 8, an example of an anomaly detection control is shown. In general, an anomaly detection control measures criteria of data over time to detect significant changes (e.g., anomalies) that may be indicative of a data quality issue. Anomaly detection controls can be defined once at a logical level and automatically propagated down to the multiple data items in accordance with the techniques described herein. In this example, a metadata model 850 includes a control node 852 representing an anomaly detection control 802 that performs a check to identify a change in day-over-day percent completeness and is defined with respect to a BDE “Loans” represented by node 854. As such, the control 802 can be automatically applied against all data associated with the BDE “Loans” in the metadata model 850 to measure the percent completeness of the data. If the day-over-day completeness in the data increases or decreases by more than a threshold, the control 802 can trigger an event (e.g., an alert, a message, etc.) in order to warn of the potential data quality issue.

As noted above, the anomaly detection control 802 is defined with respect to the “Loans” BDE node 854, which is represented in the metadata model 850 by anomaly detection control node 852 being linked by an edge to the “Loans” BDE node 854. Under normal operation, the anomaly detection control 802 propagates down the metadata model 850 from node 852 to BDE node 856a (“US Loans”) and BDE node 856b (“European Loans”), and then down to TDEs 858a, . . . , 858f and datasets 860a, 860b. In this manner, the anomaly detection control 802 only needs to be defined a single time at a logical level and then is automatically applied to all items of underlying data.

In some examples, it may be desirable to apply the anomaly detection control 802 (or another control, rule, or other logic) to data in only a portion or segment of the metadata model 850. For example, an anomaly detected by the control when applied at the “Loans” level may not indicate whether the anomaly is due to data underlying “US Loans” or data underlying “European Loans.” Therefore, in some cases, it can be beneficial to apply the anomaly detection control 802 (or another control) to a particular segment 862 of the metadata model 850. To do so, execution engine 212 can receive (e.g., from client device 220) instructions to apply the control to the segment 862 (e.g., “US Loans”) of the metadata model 850. Execution engine 212 can pass these instructions to control identifier 210, which can then identify applicable controls and characteristics for the segment, which can be returned to execution engine 212. Using this information, execution engine 212 can generate executable instructions to apply the anomaly detection control 802 to data corresponding to the segment 862 of the metadata model 850. Segmenting in this way enables top-down controls to be applied with greater granularity, thereby facilitating improved data governance in certain scenarios and aiding in the identification of the root cause of data quality issues.

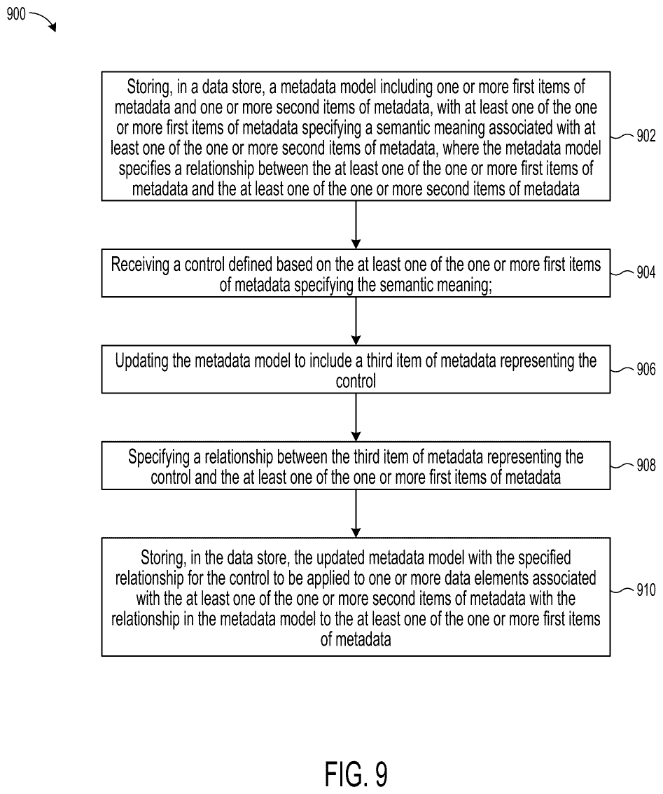

Referring to FIG. 9, a process 900 is shown for generating metadata controls for data processing. Operations of the process 900 include storing, in a data store, a metadata model including one or more first items of metadata and one or more second items of metadata (902). At least one of the one or more first items of metadata can specify a semantic meaning associated with at least one of the one or more second items of metadata. The metadata model can specify a relationship between the at least one of the one or more first items of metadata and the at least one of the one or more second items of metadata.

A control defined based on the at least one of the one or more first items of metadata specifying the semantic meaning is received (904). The metadata model is updated to include a third item of metadata representing the control (906). A relationship between the third item of metadata representing the control and the at least one of the one or more first items of metadata is specified (908). The updated metadata model with the specified relationship for the control is stored in a data store to be applied to one or more data elements associated with the at least one of the one or more second items of metadata with the relationship in the metadata model to the at least one of the one or more first items of metadata (910).

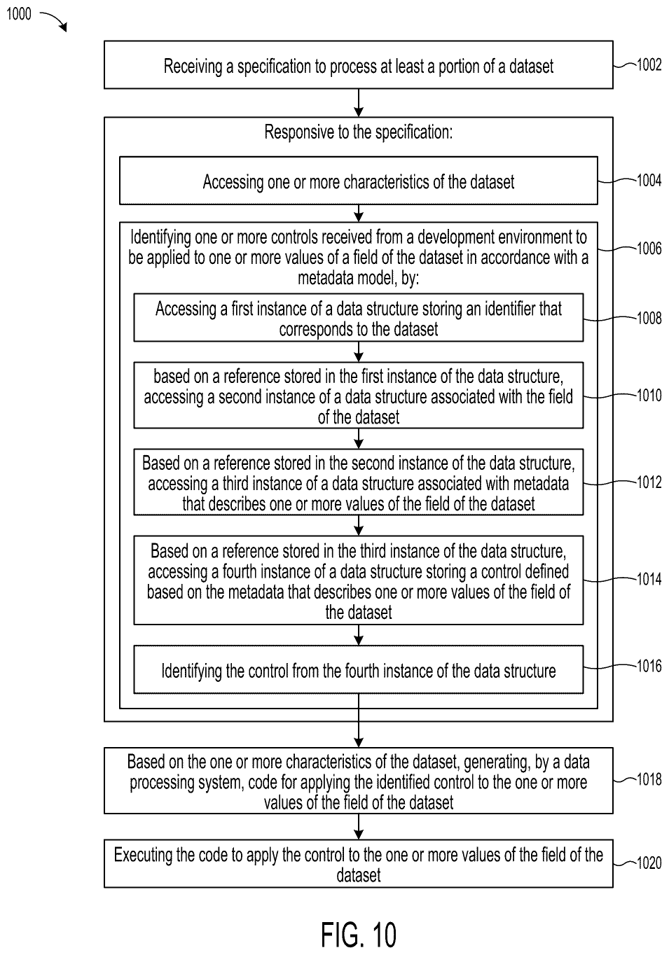

Referring to FIG. 10, a process 1000 is shown for applying metadata controls for data processing. Operations of the process 1000 include receiving a specification to process at least a portion of a dataset (1002). Responsive to the specification, one or more characteristics of the dataset are accessed (1004), one or more controls received from a development environment that to be applied to one or more values of a field of the dataset in accordance with a metadata model are identified (1006), by: accessing a first instance of a data structure storing an identifier that corresponds to the dataset (1008); based on a reference stored in the first instance of the data structure, accessing a second instance of a data structure associated with the field of the dataset (1010); based on a reference stored in the second instance of the data structure, accessing a third instance of a data structure associated with metadata that describes one or more values of the field of the dataset (1012); based on a reference stored in the third instance of the data structure, accessing a fourth instance of a data structure storing a control defined based on the metadata that describes one or more values of the field of the dataset (1014); and identifying the control from the fourth instance of the data structure (1016).

Based on the one or more characteristics of the dataset, code for applying the identified control to the one or more values of the field of the dataset is generated (1018). The code is executed to apply the control to the one or more values of the field of the dataset (1020).

### Example Computing Environment

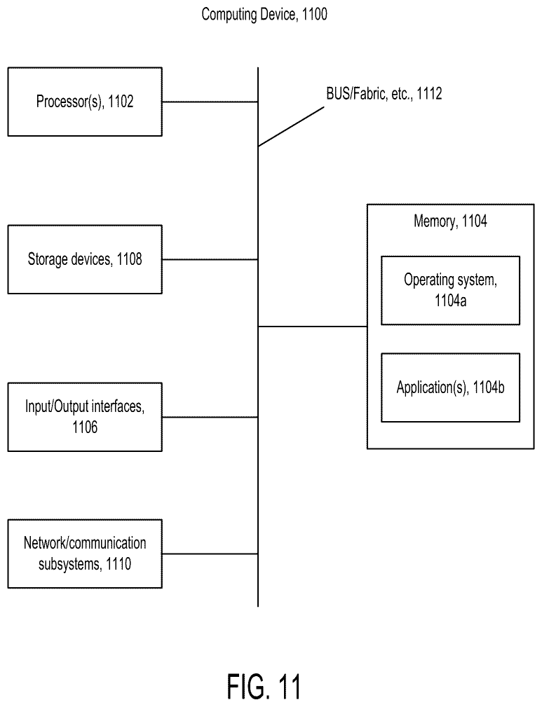

Referring to FIG. 11, an example operating environment for implementing embodiments of the present invention is shown and designated generally as computing device 1100. Essential elements of a computing device 1100 or a computer or data processing system or client or server are one or more programmable processors 1102 for performing actions in accordance with instructions and one or more memory devices 1104 for storing instructions and data. Generally, a computer will also include, or be operatively coupled, (via bus 1112, fabric, network, etc.) to I/O components 1106, e.g., display devices, network/communication subsystems, etc. (not shown) and one or more mass storage devices 1108 for storing data and instructions, etc., and a network communication subsystem 1110, which are powered by a power supply (not shown). In memory devices 1104, are an operating system 1104a and applications 1104b for application programming.

The computer program instructions and data may be stored in non-transitory form, such as being embodied in a hardware storage device, including, e.g., a volatile storage medium (e.g., random access memory (RAM)) or a non-volatile storage medium (e.g., disk), or any other non-transitory medium, using a physical property of the medium (e.g., magnetic domains, or electrical charge) for a period of time (e.g., the time between refresh periods of a dynamic memory device such as a dynamic RAM). In preparation for loading the instructions, the software may be provided on a tangible, non-transitory medium, such as a CD-ROM or other computer-readable medium (e.g., readable by a general or special purpose computing system or device), or may be delivered (e.g., encoded in a propagated signal) over a communication medium of a network to a tangible, non-transitory medium of a computing system where it is executed. Some or all of the processing may be performed on a special-purpose computer or using special-purpose hardware, such as coprocessors or field-programmable gate arrays (FPGAs) or dedicated, application-specific integrated circuits (ASICs). The processing may be implemented in a distributed manner in which different parts of the computation specified by the software are performed by different computing elements. Each such computer program is stored on or downloaded (from a cloud computing infrastructure or other remote source) to a computer-readable storage medium (e.g., solid state memory or media, or magnetic or optical media) of a storage device accessible by a general or special purpose programmable computer, for configuring and operating the computer when the storage device medium is read by the computer to perform the processing described herein. Each such computer program may also be accessed as a service provided by cloud computing infrastructure. The embodiments described herein may also be implemented as a tangible, non-transitory medium configured with a computer program, where the medium so configured causes a computer to operate in a specific and predefined manner to perform one or more of the processing steps described herein.

The computer program may include one or more modules of a larger program, for example, that provides services related to the design, configuration, and execution of dataflow graphs. The modules of the program (e.g., elements of a dataflow graph) can be implemented as data structures or other organized data conforming to a data model stored in a data repository.

To provide for interaction with a user, embodiments of the subject matter described in this specification can be implemented on a computer having a display device (monitor) for displaying information to the user, and a keyboard and a pointing device, (e.g., a mouse or a trackball) by which the user can provide input to the computer. In addition, a computer can interact with a user by sending documents to and receiving documents from a device that is used by the user (for example, by sending web pages to a web browser on a user's device in response to requests received from the web browser). Embodiments of the subject matter described in this specification can be implemented in a computing system that includes a back-end component (e.g., as a data server), or that includes a middleware component (e.g., an application server), or that includes a front-end component (e.g., a user computer having a graphical user interface or a Web browser through which a user can interact with an implementation of the subject matter described in this specification), or any combination of one or more such back end, middleware, or front end components. The components of the system can be interconnected by any form or medium of digital data communication (e.g., a communication network). Examples of communication networks include a local area network (“LAN”), a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship with each other. In some embodiments, a server transmits data (e.g., an HTML page) to a client device (e.g., for purposes of displaying data to and receiving user input from a user interacting with the user device). Data generated at the client device (e.g., a result of the user interaction) can be received from the client device at the server.

Any computation described herein can be expressed as a dataflow graph having dataflow graph components (e.g., data processing components and/or datasets). A dataflow graph can be represented by a directed graph that includes nodes or vertices, representing the dataflow graph components, connected by directed links or data flow connections, representing flows of work elements (e.g., data) between the dataflow graph components. The data processing components include code for processing data from at least one data input, (e.g., a data source) and providing data to at least one data output, (e.g., a data sink) of a system. The dataflow graph can thus implement a graph-based computation performed on data flowing from one or more input datasets through the graph components to one or more output datasets. The dataflow graph itself is executable, e.g., by compiling or otherwise processing the dataflow graph to generate executable computer code. A system for executing such graph-based computations is described in U.S. Pat. No. 5,966,072, titled “Executing Computations Expressed as Graphs,” incorporated herein by reference.

A component may be an upstream component, a downstream component, or both. An upstream component includes a component that outputs data to another component. A downstream component includes a component that receives data from another component. Additionally, components include input and output ports. The links are directed links that are coupled from an output port of an upstream component to an input port of a downstream component. The ports have indicators that represent characteristics of how data is written to and read from the links and/or how the components are controlled to process data. These ports may have various characteristics. For example, one characteristic of a port is its directionality as an input port or output port. The directed links represent data and/or control being conveyed from an output port of an upstream component to an input port of a downstream component.

A subset of the components serves as sources and/or sinks of data from the overall computation, for example, to and/or from data files, database tables, and external data flows. Parallelism can be achieved at least by enabling different components to be executed in parallel by different processes (hosted on the same or different server computers or processor cores), where different components executing in parallel on different paths through a dataflow graph is referred to as component parallelism, and different components executing in parallel on different portions of the same path through a dataflow graph is referred to as pipeline parallelism.

Generally applicable to executable dataflow graphs described herein, the executable dataflow graph implements a graph-based computation performed on data flowing from one or more input datasets of a data source through the data processing components to one or more output datasets, wherein the dataflow graph is specified by data structures in the data storage, the dataflow graph having the nodes that are specified by the data structures and representing the data processing components connected by the one or more links, the links being specified by the data structures and representing data flows between the data processing components. An execution environment or runtime environment is coupled to the data storage and is hosted on one or more computers, the runtime environment including a pre-processing module configured to read the stored data structures specifying the dataflow graph and to allocate and configure system resources (e.g. processes, memory, CPUs, etc.) for performing the computation of the data processing components that are assigned to the dataflow graph by the pre-processing module, the runtime environment including the execution module to schedule and control execution of the computation of the data processing components. In other words, the runtime or execution environment hosted on one or more computers is configured to read data from the data source and to process the data using an executable computer program expressed in form of the dataflow graph.

While this specification contains many specific implementation details, these should not be construed as limitations on the scope of any inventions or of what may be claimed, but rather as descriptions of features specific to particular embodiments of particular inventions.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments, and it should be understood that the described program components and systems can generally be integrated together in a single software product or packaged into multiple software products.

A number of embodiments have been described. Nevertheless, it will be understood that various modifications may be made without departing from the spirit and scope of the techniques described herein. For example, some of the steps described above may be order independent, and thus can be performed in an order different from that described. Additionally, any of the foregoing techniques described with regard to a dataflow graph can also be implemented and executed with regard to a program. Accordingly, other embodiments are within the scope of the following claims.

What is claimed is:

1. A method implemented by a data processing system for improving data governance by defining a single control based on a semantic meaning of data and enabling the single control to be automatically applied to multiple, disparate data elements associated with the semantic meaning to govern the data elements, the method including:
storing, in a data store, a metadata model including one or more first items of metadata and one or more second items of metadata, with at least one of the one or more first items of metadata specifying a semantic meaning associated with at least one of the one or more second items of metadata, wherein the metadata model specifies a relationship between the at least one of the one or more first items of metadata and the at least one of the one or more second items of metadata;
receiving, by a data processing system, a control defined based on the at least one of the one or more first items of metadata specifying the semantic meaning;
updating, by a data processing system, the metadata model to include a third item of metadata representing the control;
specifying, by a data processing system, a relationship between the third item of metadata representing the control and the at least one of the one or more first items of metadata; and
storing, in the data store, the updated metadata model with the specified relationship for the control to be applied to one or more data elements associated with the at least one of the one or more second items of metadata with the relationship in the metadata model to the at least one of the one or more first items of metadata.

2. The method of claim 1, further including:
rendering, by a data processing system, a user interface including one or more visualizations of the one or more first items of metadata;
receiving, by a data processing system and from the user interface, selection data specifying selection of at least one of the one or more visualizations and one or more operations to be applied to data associated with the at least one of the one or more visualizations, the at least one of the one or more visualizations corresponding to the at least one of the one or more first items of metadata specifying the semantic meaning; and
generating, by a data processing system and based on the selection data, the control defined based on the at least one of the one or more first items of metadata specifying the semantic meaning.

3. The method of claim 1, further including:
receiving, by a data processing system, a specification to process the one or more data elements;
responsive to the specification,
identifying, based on the metadata model, the at least one of the one or more second items of metadata associated with the one of the one or more data elements;
identifying, based on the metadata model, the at least one of the one or more first items of metadata related to the at least one of the one or more second items of metadata;
identifying, based on the metadata model, the third item of metadata representing the control defined based on the at least one of the one or more first items of metadata specifying the semantic meaning; and
generating instructions for applying the control to the one or more data elements; and
executing the instructions to apply the control to the one or more data elements.

4. The method of claim 1, including:
applying, by the data processing system, the control to the one or more data elements, by:
accessing data specifying one or more characteristics of the one or more data elements or one or more datasets including the one or more data elements;
based on the data specifying the one or more characteristics, generating instructions for applying the control to the one or more data elements; and
executing the instructions to apply the control to the one or more data elements.

5. The method of claim 4, wherein generating the instructions for applying the control to the one or more data elements comprises:
generating first instructions for accessing, from a data store, one or more values of the one or more data elements;
generating second instructions for applying the control to the one or more values of the one or more data elements, the second instructions including at least one operation to be performed on the one or more values of the one or more data elements based on the data specifying the one or more characteristics; and
generating third instructions for storing the one or more values of the first of the dataset to which the control is applied.

6. The method of claim 1, wherein the control is defined based on at least two of the one or more first items of metadata specifying the semantic meaning, the method including:
applying, by a data processing system, the control, by:
identifying, based on the metadata model, one of the one or more second items of metadata related to each of the at least two of the one or more first items of metadata;
accessing data specifying a correlation between the one of the one or more second items of metadata related to each of the at least two of the one or more first items of metadata;
based on the data specifying the correlation, generating instructions for applying the control to a data element associated with the one of the one or more second items of metadata related to each of the at least two of the one or more first items of metadata; and
executing the instructions to apply the control to the data elements.

7. The method of claim 6, wherein generating the instructions based on the data specifying the correlation includes:
based on the data specifying the correlation, generating instructions for joining a data element associated with the one of the one or more second items of metadata related to each of the at least two of the one or more first items of metadata; and
generating instructions for applying the control to the joined data elements.

8. The method of claim 1, wherein updating the metadata model to include the third item of metadata representing the control includes:
generating an instance of a data structure that includes the metadata representing the control; and
wherein the relationship between the third item of metadata representing the control and the at least one of the one or more first items of metadata is specified by the instance of the data structure including a reference to another instance of a data structure associated with the at least one of the one or more first items of metadata, or the other instance of the data structure associated with the at least one of the one or more first items of metadata including a reference to the instance of the data structure.

9. A method implemented by a data processing system for using a development environment to automatically generate code from a multi-tiered metadata model, the method including:
receiving, by a data processing system, a specification to process at least a portion of a dataset;
responsive to the specification,
accessing, by a data processing system, one or more characteristics of the dataset; and
identifying, by a data processing system, one or more controls received from a development environment to be applied to one or more values of a field of the dataset in accordance with a metadata model, by:
accessing a first instance of a data structure storing an identifier that corresponds to the dataset;
based on a reference stored in the first instance of the data structure, accessing a second instance of a data structure associated with the field of the dataset;
based on a reference stored in the second instance of the data structure, accessing a third instance of a data structure associated with metadata that describes one or more values of the field of the dataset;
based on a reference stored in the third instance of the data structure, accessing a fourth instance of a data structure storing a control defined based on the metadata that describes one or more values of the field of the dataset; and
identifying the control from the fourth instance of the data structure;
based on the one or more characteristics of the dataset, generating, by a data processing system, code for applying the identified control to the one or more values of the field of the dataset; and
executing the code to apply the control to the one or more values of the field of the dataset.

10. The method of claim 9, wherein the one or more characteristics of the dataset comprise at least one of a primary key of the dataset, a record format of the dataset, or a data type of the field of the dataset.

11. The method of claim 9, wherein the one or more characteristics of the dataset comprise a primary-foreign key relationship with another dataset.

12. The method of claim 9, wherein the reference stored in each of the first instance of the dataset, the second instance of the dataset, and the third instance of the dataset comprises a pointer to a memory location.

13. The method of claim 9, wherein generating the code for applying the control to the one or more values of the field of the dataset comprises:
generating first code for accessing the one or more values of the field of the dataset from a data store;
generating second code for applying the control to the one or more values of the field of the dataset, the second code including at least one operation to be performed on the one or more values of the field of the dataset based on the one or more characteristics of the dataset; and
generating third code for storing the one or more values of the first of the dataset to which the control is applied.

14. The method of claim 13, wherein the at least one operation comprises an operation to transform a data type of the one or more values of the field of the dataset.

15. The method of claim 13, wherein the at least one operation comprises an operation to join the one or more values of the field of the dataset with one or more values of a field of another dataset.

16. The method of claim 9, wherein the control is defined based on the metadata that describes the one or more values of the field of the dataset and second metadata that describes one or more values of a field of another dataset.

17. The method of claim 16, wherein generating the code for applying the control to one or more values of the field of the dataset includes:
generating code for joining the one or more values of the field of the dataset with the one or more values of the field of the other dataset; and
generating code for applying the control to the joined one or more values of the field of the dataset and the one or more values of the field of the other dataset.

18. The method of claim 9, further including:
segmenting the metadata model; and
identifying, based on the segmented metadata model, the one or more controls to be applied to the one or more values of the field of the dataset.

19. The method of claim 9, wherein executing the code comprises:
compiling the code to produce executable code; and
executing the executable code to apply the control to the one or more values of the field of the dataset.

20. A system for using a development environment to automatically generate code from a multi-tiered metadata model, including:
one or more processors; and
one or more computer-readable storage devices storing instructions executable by the one or more processors to:
receive a specification to process at least a portion of a dataset; responsive to the specification,
access one or more characteristics of the dataset; and
identify one or more controls received from a development environment to be applied to one or more values of a field of the dataset in accordance with a metadata model, by:
accessing a first instance of a data structure storing an identifier that corresponds to the dataset;
based on a reference stored in the first instance of the data structure, accessing a second instance of a data structure associated with the field of the dataset;
based on a reference stored in the second instance of the data structure, accessing a third instance of a data structure associated with metadata that describes one or more values of the field of the dataset;
based on a reference stored in the third instance of the data structure, accessing a fourth instance of a data structure storing a control defined based on the metadata that describes one or more values of the field of the dataset; and
identifying the control from the fourth instance of the data structure;
based on the one or more characteristics of the dataset, generate code for applying the identified control to the one or more values of the field of the dataset; and
execute the code to apply the control to the one or more values of the field of the dataset.
